(19) United States
(12) Patent Application Publication
(10) Pub. No.: US 2025/0140990 A1
(43) Pub. Date: May 1, 2025

(54) ADDITIVE FOR IRON-AIR BATTERIES

(71) Applicant: Form Energy, Inc., Somerville, MA (US)

(72) Inventors: Caitlin Bentley, Wilmington, MA (US); Olivia Taylor, Somerville, MA (US); Annelise Thompson, Somerville, MA (US); Zachariah Norman, Somerville, MA (US); Cleo Kyriakides, Somerville, MA (US); Sydney Gray, Somerville, MA (US); Kjell William Schroder, Somerville, MA (US); Michael Gibson, Somerville, MA (US); Abigail Taussig, Cambridge, MA (US)

(73) Assignee: Form Energy, Inc., Somerville, MA (US)

(21) Appl. No.: 18/926,383

(22) Filed: Oct. 25, 2024

Related U.S. Application Data
(60) Provisional application No. 63/546,010, filed on Oct. 27, 2023.

(51) Int. Cl. H01M 12/08; H01M 4/38; H01M 4/62

(52) U.S. Cl. CPC H01M 12/08; H01M 4/38; H01M 4/62; H01M 2300/0014

(57) ABSTRACT

An alkaline electrolyte including: an alkaline solution having a total hydroxide concentration of greater than 1 molar, based on a total volume of the alkaline electrolyte; and an additive including a trivalent element, wherein a concentration of the trivalent element is 1 millimolar to 5 molar, based on a total volume of the alkaline electrolyte, sulfur, and tin.

### CROSS REFERENCE TO RELATED APPLICATION

This application is based on and claims priority to U.S. Provisional Application No. 63/546,010, filed on Oct. 27, 2023, in the U.S. Patent and Trademark Office, and all the benefits accruing therefrom under 35 U.S.C. § 119, the contents of which are incorporated herein in its entirety by reference.

### BACKGROUND

The present subject matter relates to an additive for iron-air batteries, an electrode, electrolyte, or battery comprising the additive, methods of use, and methods of manufacturing thereof.

Rechargeable batteries help solve the problem of discontinuous production of electrical energy and allow for storing electrical energy when electricity supply does not match electricity demand. Iron-air rechargeable batteries are a promising technology for energy storage. Iron-air batteries leverage low-cost materials, e.g., iron and oxygen from ambient air, to reversibly store energy. There remains a continuing need for improved iron-air battery materials.

### SUMMARY

Disclosed is an alkaline electrolyte including: an alkaline solution having a total hydroxide concentration of greater than 1 molar, based on a total volume of the alkaline electrolyte; and an additive including a trivalent element, wherein a concentration of the trivalent element is 1 millimolar to 5 molar, based on a total volume of the alkaline electrolyte, sulfur, and tin.

Also disclosed is an alkaline electrolyte including: an alkaline solution having a total hydroxide concentration of greater than 1 molar, based on a total volume of the alkaline electrolyte; a trivalent element, wherein a concentration of the trivalent element is 10 to 250 millimolar, preferably 20 to 200 millimolar (mM), or 1 to 5 molar, preferably 2 to 3 molar, based on the total volume of the alkaline electrolyte; tin; and sulfur, wherein a concentration of the sulfur is 0.01 mM to 0.5 M, preferably 0.1 mM to 0.1 M, based on the total volume of the alkaline electrolyte.

Also disclosed is an alkaline electrolyte for an iron-air battery, the electrolyte including: an alkaline solution having a total hydroxide concentration of greater than 1 molar, based on a total volume of the alkaline electrolyte; aluminum, wherein a concentration of the aluminum is 10 millimolar to 250 millimolar, or 1 to 5 molar, preferably 2 to 3 molar, based on the total volume of the alkaline electrolyte; sulfur, wherein a concentration of the sulfur is 0.01 mM to 0.5 M, preferably 0.1 mM to 0.1 M, based on the total volume of the alkaline electrolyte; and tin, wherein a concentration of the tin is 30 millimolar to 500 millimolar, preferably 60 to 400 millimolar, based on the total volume of the alkaline electrolyte.

Also disclosed is an electrode for an electrochemical cell, the electrode including: iron; and an additive including a trivalent element, wherein a content of the additive is greater than 0.01 wt %, preferably 0.01 to 50 wt %, or more preferably 5 to 10 wt %, based on a total weight of the iron in the electrode.

Also disclosed is an electrode for an electrochemical cell, the electrode including: iron; and an additive including aluminum, sulfur, and tin, wherein a content of the aluminum is 5 to 10 wt %, based on a total weight of the iron in the electrode, wherein a content of the sulfur is 0.1 to 10 wt %, based on the total weight of the iron in the electrode, and wherein a content of the tin is 0.1 to 10 wt %, based on the total weight of the iron in the electrode.

Also disclosed is an electrochemical cell including: a first electrode including iron; the alkaline electrolyte; and a second electrode.

Also disclosed is an electrochemical cell including: a first electrode including the electrode; an alkaline electrolyte; and a second electrode.

Also disclosed is an iron-air battery, including: a plurality of the electrochemical cells, wherein the electrochemical cells are connected in series, parallel, or a combination thereof.

Also disclosed is a method of manufacturing an alkaline electrolyte, the method including: providing an alkaline solution having a total hydroxide concentration of greater than 1 molar, based on a total volume of the alkaline electrolyte; providing an additive including a trivalent element, tin, and sulfur; and contacting the alkaline solution and the additive to manufacture the alkaline electrolyte.

Also disclosed is a method of manufacturing an electrode for an electrochemical cell, the method including: contacting iron, and an additive including aluminum, sulfur, and tin to provide an electrode composition; and disposing the electrode composition on a substrate, or extruding or pressing the electrode composition to manufacture the electrode.

Also disclosed is a method of manufacturing an electrochemical cell, the method including: providing a cell stack including a first electrode, and a second electrode; and contacting the cell stack with the alkaline electrolyte to manufacture the electrochemical cell. 68

Also disclosed is a method of manufacturing an iron-air cell, the method including: providing a cell stack including the first electrode, and a second electrode; and contacting the cell stack with an alkaline electrolyte to manufacture the iron-air cell. 70

Also disclosed is a method of manufacturing an iron-air battery, the method including: providing a plurality of the electrochemical cells, and connecting the electrochemical cells in series, parallel, or a combination thereof to manufacture an iron-air battery. 72

Also disclosed is a method of operating an electrochemical cell, the method including: treating the electrochemical cell to an operation temperature, wherein the operation temperature is 0° C. to 75° C.; and discharging the electrochemical cell to operate the electrochemical cell.

The above and other aspects and features are described and exemplified by the following figures and detailed description.

### BRIEF DESCRIPTION OF THE DRAWINGS

The following figures are exemplary embodiments wherein the like elements are numbered alike.

FIG. 1A is a schematic representation of an embodiment of an iron-air cell;

FIG. 1B is a schematic representation of another embodiment of an iron-air cell;

FIG. 2 is a graph of specific discharge capacity (mAh/g) versus cycle number for the cells of Example 1, Comparative Example 1, and Comparative Example 2;

FIG. 3 is a graph of discharge capacity weighted average voltage (V) versus cycle number for the cells of Example 1, Comparative Example 1, and Comparative Example 2 at 45° C.;

FIG. 4 is a graph of discharge capacity weighted average voltage (V) versus cycle number for the cells of Example 1, Comparative Example 1, and Comparative Example 2 at 30° C.;

FIG. 5 is a graph of high voltage reaction capacity fraction versus cycle number for the cells of Example 1, Comparative Example 1, and Comparative Example 2;

FIG. 6 is a graph of energy efficiency fraction versus cycle number for the cells of Example 1, Comparative Example 1, and Comparative Example 2;

FIG. 7 is a graph of specific discharge capacity (mAh/g) versus cycle number for the cells of Example 1, Comparative Example 1, Comparative Example 2, and Example 2;

FIG. 8 is a graph of discharge capacity weighted average (V) versus cycle number for the cells of Example 1, Comparative Example 1, Comparative Example 2, and Example 2;

FIG. 9 is a graph of high voltage reaction capacity fraction versus cycle number for the cells of Example 1, Comparative Example 1, Comparative Example 2, and Example 2;

FIG. 10 is a graph of energy efficiency fraction versus cycle number for the cells of Example 1, Comparative Example 1, Comparative Example 2, and Example 2; and

FIG. 11 is a graph of cell voltage (V) versus capacity (mAh/g) of Example 3.

### DETAILED DESCRIPTION

Metal-air batteries are electrochemical cells that include a metal negative electrode, a positive electrode that is exposed to air, and an aqueous or aprotic or solid state electrolyte. During discharge of a metal-air battery, a reduction reaction occurs at the positive electrode and the metal negative electrode is oxidized. Recently, interest in developing iron-air batteries for grid-scale energy storage has increased because the primary material of iron-air batteries is iron oxide, which is an abundant, inexpensive, non-toxic, and economical material.

Half-cell reactions at an iron negative electrode that occur during discharge and oxidation in an alkaline electrolyte are as provided by Equations 1 and 2.

$$Fe + 2 {OH}^{-} ⇆ {Fe ( O H )}_{2} + 2 {e}^{-} \qquad ( Equation 1 )$$

$$3 F {e ( O H )}_{2} + 2 O {H}^{-} ⇆ {Fe}_{3} {O}_{4} + 4 {H}_{2} O + 2 {e}^{-} \qquad ( Equation 2 )$$

While not wanting to be bound by theory, it is understood that as provided in Equation 1, iron hydroxide (Fe(OH)₂) is formed on the surface of the iron electrode, and as provide in Equation 2, the iron hydroxide is understood to subsequently oxidize further to form magnetite (Fe₃O₄). The theoretical capacity, based on metallic iron, according to the negative electrode reactions are 960 milliampere hours per gram (mAh/g) of iron in Equation 1, and 320 mAh/g of iron in Equation 2.

The Applicants have discovered that inclusion of a trivalent element in the alkaline electrolyte of an iron-air battery provides surprisingly improved performance, such as improved efficiency, cyclability, rate capability, or discharge throughput. Further still, inclusion of tin, sulfur, or tin and sulfur with the trivalent element can provide additional beneficial effects. While not wanting to be bound by theory, it is understood that the trivalent element in the alkaline electrolyte limits the solubility of silica in the electrolyte, resulting in the observed benefits. It is further understood that when the trivalent element is aluminum, the aluminum substitutes in place of iron in the cubic oxygen lattices common to iron oxides and oxy-hydroxides, and thereby enhances the conversion of oxides at advantageous voltages. Also, aluminate ions, in conjunction with free iron ions and silica, are understood to form inorganic solids similar in form to cement, which enhance the mechanical robustness of the iron electrode. Thus, and while not wanting to be bound by theory, it is understood that the sulfur has the effect of improving bonding between the iron particles of the negative electrode, improving mechanical stability. Further, an anion of the trivalent element is understood to facilitate hydroxide transport at the surface of a negative electrode, facilitating electrochemical oxidation and reduction of the negative electrode. In this way, a beneficial additive is introduced to the system while preventing an undesirable energy loss mechanism. While not wishing to be bound by theory, it is understood that the incorporation of the trivalent element, in particular aluminum, in the discharge product stabilizes the magnetite phase and inhibits further oxidation of magnetite to maghemite, wherein the magnetite is a less conductive and therefore reversible electrochemical product. In further detail and again not wishing to be bound by theory, the aluminate ions are understood to coordinate high energy surface sites in the iron negative electrode and thereby modulate iron oxide formation processes. Thus use of the trivalent element (preferably aluminum) and tin, or the use of the trivalent element (preferably aluminum) and sulfur, or the use of the trivalent element (preferably aluminum), and tin and sulfur is understood to provide desirable stabilization of the magnetite phase, inhibition of further oxidation of magnetite to maghemite, limitation of the solubility of silica in the electrolyte, and improved mechanical stability.

An aspect provides an alkaline electrolyte comprising an aqueous solution including one or more suitable hydroxide compounds. The electrolyte may include, for example, an alkali hydroxide, an alkaline earth hydroxide, an organic hydroxide, or a combination thereof. In some embodiments, the electrolyte may comprise KOH, NaOH, LiOH, RbOH, CsOH, FrOH, Be(OH)₂, Ca(OH)₂, Mg(OH)₂, Sr(OH)₂, Ra(OH)₂, Ba(OH)₂, or a combination thereof. A combination including at least one of the foregoing hydroxides may be used. In an aspect, the electrolyte may comprise KOH, NaOH, LiOH, or a combination thereof. Also, in some aspects, a molar concentration of KOH may be greater than a molar concentration of NaOH, and the molar concentration of NaOH may be greater than a molar concentration of LiOH. In an aspect, the electrolyte includes KOH and NaOH and a molar concentration of KOH is greater than a molar concentration of NaOH. In still other aspects, a molar concentration of KOH and/or NaOH is greater than a molar concentration of LiOH.

In an aspect, a total hydroxide concentration in the alkaline electrolyte may be 1 M (molar) or greater. For example, a total hydroxide concentration of the alkaline electrolyte may be 1 M to 10 M, 2 M to 9 M, 3 M to 8 M, or 4 M to 8 M. In an aspect, a concentration of LiOH is 0.01 M to 0.1 M, or 0.02 M to 0.08 M. As used herein, the term “total hydroxide concentration” refers to the total concentration of hydroxide species in the alkaline electrolyte.

In an aspect, a pH of the alkaline electrolyte may be greater than a pH of 10. For example, the pH of the alkaline electrolyte may be greater than 11, greater than 12, greater than 13, or greater than 14, and may be 9 to 15, 10 to 14, or 11 to 13.

The solvent in the alkaline electrolyte is water, and the electrolyte is preferably prepared using high purity water, such as de-ionized water. While not wanting to be bound by theory, it is understood that the use of de-ionized water avoids dissolved silicates, which may otherwise be present in water that is not de-ionized, thus avoiding the undesirable effects that may be associated with the dissolved silicates. In an aspect, a content of silicates in the electrolyte is less than 300 ppm, e.g., 0.01 ppm to 100 ppm, or 0.01 to 10 ppm.

The alkaline electrolyte may be a liquid, a solid, a gel, or a combination thereof. The gel may be a semi-solid having properties between a liquid and a solid, and able to retain its shape when unsupported. In an aspect, use of a liquid for the alkaline electrolyte is mentioned.

The alkaline electrolyte includes an additive that includes a trivalent element. The trivalent element may be an element of Group 3 or Group 13 of the Periodic Table of Elements, and may be aluminum, scandium, yttrium, boron, or a combination thereof. Aluminum, or a trivalent metalloid such as Sb or B, are mentioned. The additive comprising the trivalent element may be a metal or metalloid, an oxyanion, an oxide, a hydroxide, or a combination thereof. The trivalent element may be provided by oxidation or dissociation of a compound or metal comprising the trivalent element.

In an aspect, the trivalent element comprises aluminum. The aluminum may be provided by oxidation or dissociation of a compound or metal comprising the aluminum. The a compound or metal comprising the aluminum may be aluminum metal, an aluminate, hydrated aluminate, aluminum oxide (alumina), hydrate aluminum oxide, aluminum hydroxide, or a combination thereof. In some embodiments, the aluminate may include the anhydrous form AlO₂⁻, the hydrated form Al(OH)₄⁻, or a combination thereof. In an aspect, the additive may be potassium aluminate, sodium aluminate, silica aluminate, iron aluminate, aluminum hydroxide, aluminum metal, alumina, or a combination thereof. Mentioned is an aspect wherein the additive comprises an aluminate.

In an aspect, the trivalent element may include scandium. Exemplary scandium compounds for the additive include, but are not limited to, scandium metal, scandium (III) hydroxide (Sc(OH)₃), scandium (III) oxide (Sc₂O₃), scandium (III) chloride, scandium (III) nitrate, scandium (III) acetate, or the like, or a combination thereof.

In an aspect, the trivalent element may include yttrium. Exemplary yttrium compounds for the additive include, but are not limited to, yttrium metal, yttrium hydroxide (Y(OH)₃), yttrium oxide (Y₂O₃), yttrium (III) chloride, yttrium (III) acetate, yttrium (III) nitrate, yttrium iron oxide, or the like, or a combination thereof.

In an aspect, the trivalent element may include boron. Exemplary boron compounds for the additive include, but are not limited to, potassium tetrahydroxyborate (K[B(OH)₄]) or sodium tetrahydroxyborate (Na[B(OH)₄]) to provide a corresponding tetrahydroxyborate anion, [B(OH)₄]; tripotassium orthoborate (K₃(BO₃)) or trisodium orthoborate (Na₃[BO₃]) to provide a corresponding orthoborate anion, [BO₃]³⁻; sodium metaborate (Na₃[B₃O₆]) to provide [BO₂] or the cyclic trimer [B₃O₆]³⁻; sodium tetraborate (Na₂[B₄O₇]) to provide [B₄O₇]²⁻; a boric acid, such as orthoboric acid (B(OH)₃), metaboric acid (HBO₂), or tetraboric acid (H₂B₄O₇); or the like, or a combination thereof.

In an aspect, the additive may comprise a compound that comprises more than one trivalent element, preferably more than one of aluminum, boron, scandium, or yttrium. For example, the additive may be potassium aluminum borate (K₂Al₂B₂O₇), calcium aluminum triborate (Ca[AlB₃O₇]), yttrium borate, yttrium aluminum oxide, yttrium aluminum borate, or the like, or a combination thereof.

The additive comprising the trivalent element may be included in the alkaline electrolyte in any suitable amount or concentration. A concentration of the trivalent element may be greater than 1 millimolar (mM), preferably 1 mM to 5 M, based on a total volume of the alkaline electrolyte. For example, the trivalent element may be present in the alkaline electrolyte in a concentration of 10 to 250 mM, 50 to 200 mM, or 75 to 150 mM, based on a total volume of the alkaline electrolyte. In some embodiments, the trivalent element may be present in the alkaline electrolyte in a concentration of 1 to 250 mM, 20 to 200 mM, 40 to 150 mM, 60 to 130 mM, or 70 to 120 mM, based on a total volume of the alkaline electrolyte. In still other embodiments, the trivalent element may be present in the alkaline electrolyte in a concentration of 0.5 to 5 M, 0.75 to 4.5 M, 1 to 4 M, or 2 to 3 M, based on a total volume of the alkaline electrolyte.

Mentioned is use of the additive comprising aluminate, wherein a concentration of the aluminate in the alkaline electrolyte may be greater than 1 mM, preferably 1 mM to 5 M, based on a total volume of the alkaline electrolyte. For example, the concentration of the aluminate in the alkaline electrolyte may be 10 to 250 mM, 50 to 200 mM, or 75 to 150 mM, based on the total volume of the alkaline electrolyte. In some embodiments, a concentration of the aluminate in the alkaline electrolyte may be 1 to 250 mM, 10 to 150 mM, 20 to 140 mM, 60 to 130 mM, or 70 to 120 mM, based on the total volume of the alkaline electrolyte. In still other embodiments, the aluminate may be present in the alkaline electrolyte in a concentration of 0.5 to 5 M, 0.75 to 4.5 M, 1 to 4 M, or 2 to 3 M, based on the total volume of the alkaline electrolyte.

In an aspect, the additive may comprise sulfur, and the sulfur may be in the form of a sulfur-containing compound. The sulfur-containing compound may be a sulfide, a sulfite, a sulfate, a thiosulfate, a polysulfide, or a combination thereof. Non-limiting examples of the sulfur-containing compound include sodium sulfide, sodium sulfite, sodium sulfate, sodium thiosulfate, sodium tetrasulfide, zinc sulfide, zinc sulfite, zinc sulfate, or zinc thiosulfate. Representative sulfides include an alkali metal sulfide, such as lithium sulfide, sodium sulfide, or potassium sulfide, or a transition metal sulfide, such as nickel sulfide or zinc sulfide. A combination comprising at least one of the foregoing may be used. Mentioned is use of sodium sulfide, zinc sulfide, or a combination thereof. Use of zinc sulfide is mentioned. Including sulfur, e.g., the sulfide, results in unexpectedly improved charge and discharge performance.

The alkaline electrolyte may contain the sulfur-containing additive, and a concentration of the sulfur in the alkaline electrolyte may be 0.01 millimolar to 0.5 M, based on a total volume of the alkaline electrolyte. For example, a concentration of the sulfur-containing additive, or a concentration of sulfur in the alkaline electrolyte may be 0.01 to 300 mM, 0.03 to 100 mM, 0.07 to 50 mM, or 0.1 to 10 mM, based on the total volume of the alkaline electrolyte. In an aspect, the sulfur content in the electrolyte may be 0.01, 0.05, 0.1, 0.2, 0.3, 0.4, 0.5, 1, 2, or 5 mM to 10, 20, 25, 50, 100, 150, 200, or 300 mM, based on the total volume of the alkaline electrolyte.

A content of the sulfur-containing additive, or a content of the sulfur, or a content of the sulfide in the alkaline electrolyte may be greater than 0.01 weight percent (wt %), based on the total weight of the alkaline electrolyte, or 0.01 to 20 wt %, 0.2 to 10 wt %, 0.3 to 5 wt %, or 0.5 to 2 wt %, based on a total weight of the alkaline electrolyte. In an aspect, the content of the sulfur-containing additive, or the content of the sulfur, or the content of the sulfide in the alkaline electrolyte may be 0.01, 0.05, 0.1, 0.2, 0.3, 0.4, 0.5, or 1 wt % to 1.5, 2, 3, 5, 12, 15, 18, or 20 wt %, based on the total weight of the alkaline electrolyte. As noted below, the endpoints of such ranges are independently combinable.

In an aspect, the sulfide may be included in the additive in the alkaline electrolyte to provide a sulfide concentration of 0.01 to 300 mM, 0.03 to 100 mM, 0.07 to 50 mM, or 0.1 to 10 mM, based on a total volume of the alkaline electrolyte. When the sulfur is present, the content of the trivalent element may be 1 mM to 5 M, in an aspect, 10 to 500 mM, 50 to 250 mM, or 75 to 150 mM, based on the total volume of the alkaline electrolyte. Alternatively, when the sulfur is present, the content of the trivalent element may be 1 to 5 M, 1.5 to 4 M, or 2 to 3 M, based on the total volume of the alkaline electrolyte.

In an aspect, no additional sulfide is added to the alkaline electrolyte. In an aspect, the alkaline electrolyte may have no sulfide therein. In some embodiments, the sulfide may be provided in other aspects of the electrochemical cell and not included in the alkaline electrolyte. As an example, the additive comprising a sulfide-containing compound may be included in the first electrode and the sulfide not included in the alkaline electrolyte. For example, the alkaline electrolyte may have no detectable sulfide therein, e.g., the alkaline electrolyte may have a sulfide concentration of less than 1 nanomolar (nM), 0.001 to 1 nM, or 0.01 to 0.1 nM.

Mentioned is an aspect wherein the alkaline electrolyte comprises the trivalent element and sulfur, preferably wherein the trivalent element is aluminum, and wherein preferably the sulfur is provided as a sulfide. In an aspect where the alkaline electrolyte comprises the aluminum, the aluminum may be present in the alkaline electrolyte in a concentration of 1 mM to 5 M, in an aspect, 10 to 500 mM, 50 to 250 mM, or 75 to 150 mM, based on the total volume of the alkaline electrolyte. Alternatively, when the alkaline electrolyte comprises the aluminum, the aluminum may be present in the alkaline electrolyte in a concentration of 1 to 5 M, 1.5 to 4 M, or 2 to 3 M, based on the total volume of the alkaline electrolyte.

It has been discovered that use of the trivalent element and sulfur provides beneficial effects. While not wanting to be bound by theory, it is understood that the trivalent element can form a complex with sulfur. The sulfur may be provided as a sulfide. While not wanting to be bound by theory, it is understood that when in solution, a sulfide complex comprising the trivalent element forms, and the trivalent element-sulfide complex modulates the amount of available trivalent element and sulfide in the electrolyte or at the interface of the negative electrode. The formation of this sulfide complex can be determined by changes to the equivalence point as measured by titration versus a solution of hydrochloric acid (e.g., using a solution of hydrochloric acid) with a known molarity. In an aspect where the trivalent element is aluminum, an aluminum-sulfide complex may form, and the aluminum-sulfide complex modulates the amount of available aluminum and sulfide in solution or at the interface of the negative electrode. In a non-limiting example, the trivalent element is aluminum and the additive is a sulfide, preferably a hydrosulfide. Further, while not wanting to be bound by theory, it is understood that the trivalent element-sulfide complex results in improved mechanical stability of the negative electrode.

The trivalent element and the sulfur may be provided in a same additive, e.g., as a compound that comprises the trivalent element and sulfur, such as aluminum sulfide. The trivalent element and the sulfur may be provided in distinct additives, e.g., as a first additive comprising the trivalent additive and a second additive comprising the sulfur. Use of an aluminate as a first additive and a sulfide as a second additive is mentioned.

Use of an alkaline electrolyte comprising the trivalent element and tin provides beneficial effects. In the presence of both the trivalent element (e.g., aluminum), and tin, a single voltage plateau is observed during constant current cycling at 7 to 15 mA/cm² while maintaining a discharge capacity above 350 mAh/g. This outcome is technologically advantageous because it leads to higher achievable round-trip efficiency and greater discharge power. In the presence of aluminum or tin alone, reduced efficiency and multiple voltage plateaus are observed. While not wanting to be bound by theory, it is understood that the multiple voltage plateaus indicate electrochemical reactions other than those intended may occur when either the trivalent element or the tin is omitted. Also, inclusion of aluminum allows use of less tin, providing cost benefits.

The tin may be provided as tin metal, as a tin-containing compound, or a combination thereof in the alkaline electrolyte. Exemplary tin species include tin metal, sodium stannate trihydrate (Na₂SnO₃:3H₂O), sodium stannate (Na₂SnO₃), potassium stannate trihydrate (K₂SnO₃:3H₂O), potassium stannate (K₂SnO₃), calcium stannate (CaSnO₃), magnesium stannate (MgSnO₃), barium stannate (BaSnO₃), cobalt stannate (Co₂SnO₄), tin oxide (SnO₂), tin (II) oxide, cylindrite (Pb₃Sn₄FeSb₂S₁₄), canfieldite (Ag₈SnS₆), copper iron tin sulfide (Cu₂FeSnS₄), a lead-tin alloy such as 60/40 Sn/Pb solder, a 63/37 Sn/Pb solder, a Terne I alloy comprising 10 to 20% Sn, with the balance being Pb, a zinc-tin alloy such as a Terne II alloy comprising 10 to 20% Sn, with the balance being Zn, or a tin sulfide such as SnS or SnS₂.

A concentration of the tin, e.g., a tin ion or a tin-containing compound, in the alkaline electrolyte may be greater than 30 millimolar (mM), based on a total volume of the alkaline electrolyte. For example, a concentration of the tin in the alkaline electrolyte may be 30 to 800 mM, 40 to 500 mM, 50 to 400 mM, 60 to 250 mM, or 100 to 150 mM, based on a total volume of the alkaline electrolyte.

An amount of the tin or the additive comprising tin, e.g., the tin-containing compound, in the alkaline electrolyte may be greater than 0.01 weight percent (wt %), based on the total weight of the alkaline electrolyte. For example, the tin or the additive comprising tin, may be present in the alkaline electrolyte in an amount of 0.01 to 20 wt %, 0.05 to 10 wt %, 0.1 to 5 wt %, or 0.5 to 2 wt %, based on a total weight of the alkaline electrolyte.

The trivalent element and the tin may be provided in the same additive, or as distinct additives, e.g., as a first additive comprising the trivalent additive and a second additive comprising the tin. Use of an aluminate as the first additive and potassium stannate as the second additive is mentioned.

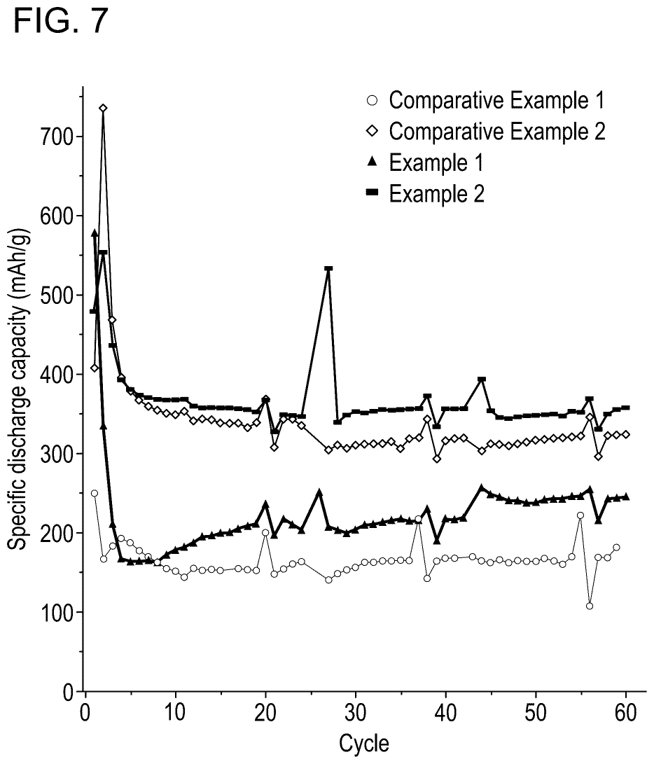

Further still, use of the trivalent element, tin, and sulfur provides beneficial effects compared to when either tin or the trivalent element or sulfur is used alone. While not wanting to be bound by theory, it has been discovered that when a content of the trivalent element is greater than 100 mM, e.g., 150 mM, use of a combination of the trivalent element, tin, and sulfur provides unexpected beneficial effects. It is theorized that some of the trivalent element is complexed by the sulfur, and thus a greater concentration of the trivalent element is preferably used when sulfur is present than when the sulfur is omitted. Additionally, the use of the trivalent element, tin, and sulfur (Example 2) provides beneficial effects compared to when tin and sulfur (Comparative Example 2), or trivalent element and sulfur (Example 1) are used as shown in FIG. 7, which will be further discussed.

In an aspect that contains aluminum, tin, and sulfur, and while not wanting to be bound by theory, interactions between the additives may impact the operation of each additive. In those conditions, it can be desirable to modulate the concentration or quantity of the additive to account for such interactions. For example, inclusion of sulfide with aluminum and tin provides improved initial discharge capacity above-0.8 volts (V) relative to a mercury/mercuric oxide reference electrode (MMO) at 10 mA/cm².

Disclosed is an alkaline electrolyte wherein a total content of the trivalent element, the tin, and the sulfur is greater than 1 mM, preferably 1 mM to 5 M, based on a total volume of the alkaline electrolyte. For example, the total concentration of the trivalent element, the tin, and the sulfur in the alkaline electrolyte may be 10 to 250 mM, 50 to 250 mM, or 100 to 250 mM, based on a total volume of the alkaline electrolyte. In some embodiments, the total concentration of the trivalent element, the tin, and the sulfur in the alkaline electrolyte may be 1 to 200 mM, 10 to 150 mM, 20 to 140 mM, 60 to 130 mM, or 70 to 120 mM, based on a total volume of the alkaline electrolyte. In still other embodiments, the total concentration of the trivalent element, the tin, and the sulfur in the alkaline electrolyte is 0.5 to 5 M, 0.75 to 5 M, 1 to 4 M, or 2 to 3 M, based on a total volume of the alkaline electrolyte. Mentioned is use of aluminum for the trivalent element.

The trivalent element, the sulfur, and the tin may be provided in the same additive, or as distinct additives, e.g., as the first additive comprising the trivalent additive, the second additive comprising the sulfur, and the third additive comprising tin. Use of an aluminate as the first additive, a sulfide as the second additive, and potassium stannate as the third additive is mentioned.

The alkaline electrolyte may further include a hydrogen evolution reaction (HER) suppressor to slow or reduce hydrogen evolution. The HER suppressor may comprise lead, indium, tin, antimony, copper, silver, bismuth, gold, an oxide thereof, or a combination thereof. The HER suppressor may be included in the alkaline electrolyte to improve charging efficiency of the iron negative electrode. Alternatively, the HER suppressor may also or alternatively be incorporated into the iron electrode. Additional details are provided in U.S. Patent Publication No. 2022/0367911, the content of which is incorporated herein in its entirety by reference for all purposes.

In addition the alkaline electrolyte may further include an iron component. In an aspect, the alkaline electrolyte further includes iron, and the iron has an oxidation state of 0, 2, 3, or a combination thereof. Exemplary iron species that may be present in the alkaline electrolyte include hypoferrite ion (HFeO₂⁻ or Fe(OH)₃⁻), iron (II) hydroxide (Fe(OH)₂), or a combination thereof. The iron may also be in a form of a complex with the trivalent element, oxygen, hydroxide, or a combination thereof. For example, the aluminate anions may form a hydroxide-bridged adduct with hypoferrite to provide a structure such as AlFe(OH)₆, but embodiments are not limited thereto.

Other oxides, such as zinc oxide, bismuth oxide, antimony oxide, or the like, or a combination thereof, may be included in the alkaline electrolyte.

### Negative Electrode

In an aspect, the trivalent element, the tin, or the sulfur can each independently be included in an electrode of a battery having an iron-containing negative electrode, such as in an electrode of an iron-air, iron-nickel, or iron-manganese battery.

In the iron-air cell, the first electrode, i.e., the negative electrode or iron electrode, comprises iron, and may be an anode on discharge. The first electrode, which may be referred to herein as the “iron electrode,” may be a solid, may be in a form of a dense monolith or a porous solid, may be in a form of a mesh or foam, and may comprise a collection or an agglomeration of particles, such as may result from bonding iron particles with heat and pressure. The first electrode may comprise a collection of particles in a form of a slurry, ink, suspension, or paste. The iron electrode may be a collection of iron particles within a suspension such that the particles are not buoyant enough to escape the suspension into the electrolyte. As another example, the iron electrode may be formed from iron particles that are not buoyant in the electrolyte.

The first electrode may be a porous iron-containing material and comprise metallic iron and various iron compounds, such as iron oxides, hydroxides, sulfides, carbides, or combinations thereof. In some embodiments, the first electrode may comprise pelletized, briquetted, pressed, powdered, and/or sintered iron-containing compounds. The iron-containing compounds may include one or more forms of iron, ranging from highly reduced (more metallic) iron to highly oxidized iron (having a higher average valence). In some embodiments, the iron electrode may be sintered agglomerates of particles having various shapes.

The iron particles may be a sponge iron or a Direct Reduced Iron (DRI). As used herein, “direct reduced iron” refers to an iron material different from sponge iron that is produced from, or obtained from the reduction of a natural or processed iron ore, such reduction being conducted without reaching the melting temperature of iron. In various embodiments the iron ore may comprise taconite, magnetite, hematite, goethite, or a combination thereof. In various embodiments, the DRI may be in the form of pellets, which may be spherical or substantially spherical. In various embodiments the DRI may be porous, containing open and/or closed internal porosity. In various embodiments the DRI may comprise materials that have been further processed by hot or cold briquetting. In various embodiments, the DRI may be produced by reducing iron ore pellets to form a more metallic (more reduced, less oxidized) material, such as iron metal (Fe⁰), wustite (FeO), or a composite pellet comprising iron metal and a residual oxide phase. In some embodiments, the DRI may be reduced iron ore taconite, direct reduced (“DR”) taconite, reduced “Blast Furnace (BF) Grade” pellets, reduced “Electric Arc Furnace (EAF)-Grade” pellets, “Cold Direct Reduced Iron (CDRI)” pellets, direct reduced iron (“DRI”) pellets, Hot Briquetted Iron (HBI), or a combination thereof. The iron particles may comprise an iron oxide, such as hematite, magnetite, maghemite, wustite, martite, goethite, limonite, siderite, pyrite, ilmenite, spinel manganese ferrite, or a combination thereof.

The iron particles may have any suitable size. The iron particles may have a D50 particle size of 40 to 700 micrometers (μm), preferably 120 to 450 μm, more preferably 150 to 450 μm. The iron particles may have a D50 particle size of 40, 60, 80, 100, 125, 150, 175, 200, 300, or 400 μm to 60, 80, 100, 125, 150, 175, 200, 300, 400, 500, 600, or 700 μm, wherein the endpoints are independently combinable. The iron particles may have an apparent density of 0.6 to 3.2 grams per cubic centimeter (g/cm³), preferably 0.8 to 1.8 g/cm³. The iron particles may have an apparent density of 0.1, 0.2, 0.3, 0.4, 0.5, 0.6, 0.7, 0.8, 1, 1.5, 2, 3, 4, 5, 6, or 7 g/cm³ to 0.2, 0.3, 0.4, 0.5, 0.6, 0.7, 0.8, 1, 1.5, 2, 3, 4, 5, 6, 7, or 7.5 g/cm³, wherein the endpoints are independently combinable.

Mentioned is use of atomized or sponge iron powders as the feedstock material for forming iron negative electrodes. For example, the iron electrode may include metallurgically-bonded sponge iron particles, such as direct reduced iron (DRI) or other sponge iron powder particles, wherein the microporosity with the sponge iron particles is greater than 50 vol % and the particle size of the sponge iron particles is greater than 100 micrometers.

In some embodiments, the iron electrode may have a surface density of 1 gram of iron per square centimeter (cm²) to 7 grams of iron/cm² or a surface density of 2 grams of iron/cm²/to 5 grams of iron/cm².

The first electrode may further include the additive that includes the trivalent element. The trivalent element may be the same or different than that included in the alkaline electrolyte. The trivalent element may be an element of Group 3 or Group 13 of the Periodic Table of Elements, and may be aluminum, scandium, yttrium, boron, or a combination thereof.

Aluminum, or a trivalent metalloid such as Sb or B, are mentioned. The additive comprising the trivalent element may be a metal or metalloid, an oxyanion, an oxide, a hydroxide, or a combination thereof. The trivalent element may be provided by oxidation or dissociation of a compound or metal comprising the trivalent element.

In an aspect, the trivalent element comprises aluminum. The aluminum may be provided by oxidation or dissociation of a compound or metal comprising the aluminum. The compound or metal comprising the aluminum may be aluminum metal, an aluminate, hydrated aluminate, aluminum oxide (alumina), hydrate aluminum oxide, aluminum hydroxide, or a combination thereof. In some embodiments, the aluminate may include the anhydrous form A₁O₂⁻, the hydrated form Al(OH)₄⁻, or a combination thereof. In an aspect, the additive may be potassium aluminate, sodium aluminate, silica aluminate, iron aluminate, aluminum hydroxide, aluminum metal, alumina, or a combination thereof. Mentioned is an aspect wherein the additive comprises an aluminate.

In an aspect, the trivalent element may include scandium. Exemplary scandium compounds for the additive include, but are not limited to, scandium metal, scandium (III) hydroxide (Sc(OH)₃), scandium (III) oxide (Sc₂O₃), scandium (III) chloride, scandium (III) nitrate, scandium (III) acetate, or the like, or a combination thereof.

In an aspect, the trivalent element may include yttrium. Exemplary yttrium compounds for the additive include, but are not limited to, yttrium metal, yttrium hydroxide (Y(OH)₃), yttrium oxide (Y₂O₃), yttrium (III) chloride, yttrium (III) acetate, yttrium (III) nitrate, yttrium iron oxide, or the like, or a combination thereof.

In an aspect, the trivalent element may include boron. Exemplary boron compounds for the additive include, but are not limited to, potassium tetrahydroxyborate (K[B(OH)₄]) or sodium tetrahydroxyborate (Na[B(OH)₄]) to provide a corresponding tetrahydroxyborate anion, [B(OH)₄]⁻, tripotassium orthoborate (K₃(BO₃)) or trisodium orthoborate (Na₃[BO₃]) to provide a corresponding orthoborate anion, [BO₃]³⁻, sodium metaborate (Na₃[B₃O₆]) to provide [BO₂]⁻ or the cyclic trimer [B₃O₆]³⁻, sodium tetraborate (Na₂[B₄O₇]) to provide [B₄O₇]²⁻, a boric acid, such as orthoboric acid (B(OH)₃), metaboric acid (HBO₂), or tetraboric acid (H₂B₄O₇), or the like, or a combination thereof.

In an aspect, the first electrode may comprise as the additive a compound that comprises more than one trivalent element, preferably more than one of aluminum, boron, scandium, or yttrium. For example, the additive may be potassium aluminum borate (K₂Al₂B₂O₇), calcium aluminum triborate (Ca[AlB₃O₇]), yttrium borate, yttrium aluminum oxide, yttrium aluminum borate, or the like, or a combination thereof.

A content of the trivalent element in the first electrode may be greater than 0.01 wt %, preferably 0.01 wt % to 50 wt %, 0.05 wt % to 40 wt %, 0.1 wt % to 30 wt %, 0.5 wt % to 25 wt %, 1 wt % to 20 wt %, 2 wt % to 15 wt %, 4 wt % to 12 wt %, or 5 wt % to 10 wt %, based on a total weight of the iron in the first electrode.

Mentioned is use of aluminum in the first electrode, preferably use of the additive comprising aluminate, wherein a concentration of the aluminum in the first electrode may be 0.01 wt %, preferably 0.01 to 50 wt %, 0.05 to 40 wt %, 0.1 to 30 wt %, 0.5 to 25 wt %, 1 to 20 wt %, 2 to 15 wt %, 4 to 12 wt %, or 5 to 10 wt %, based on a total weight of the iron in the first electrode.

In an aspect, the first electrode may comprise an additive comprising sulfur, and may comprise a sulfur-containing compound, and the sulfur-containing compound may be a sulfide. Representative sulfides include an alkali metal sulfide, such as lithium sulfide, sodium sulfide, or potassium sulfide, or a transition metal sulfide, such as nickel sulfide, or zinc sulfide. A combination comprising at least one of the foregoing may be used. Use of zinc sulfide is mentioned.

When present, an amount of the additive comprising sulfur, e.g., the sulfur or sulfide-containing compound, in the first electrode may be present to provide a sulfur content of greater than 0.001 wt %, in an aspect, 0.001 to 20 wt %, 0.01 to 15 wt %, 0.1 to 10 wt %, 1 to 10 wt %, or 3 to 7 wt %, based on a total weight of the iron in first electrode. Preferably, the sulfur content is 0.01 to 5 wt %, or 1 to 10 wt %, or more preferably 3 to 7 wt %, based on the total weight of the iron in first electrode. Mentioned is use of the additive comprising sodium sulfide, zinc sulfide, or a combination thereof to provide a sulfide content of 0.1 to 10 wt %, based on a total weight of the iron in first electrode.

In an aspect, no additional sulfur compound is added to the alkaline electrolyte. In an aspect, the first electrode may have no sulfur therein. In some embodiments, the sulfur may be provided in other aspects of the electrochemical cell and not included in the first electrode. As one example, the additive comprising a sulfide-containing compound may be included in the alkaline electrolyte and the sulfide not included in the first electrode. For example, the first electrode may have no detectable sulfide therein, e.g., the first electrode may have a sulfur concentration of less than 1 nanomolar, 0.001 to 1 mM, or 0.01 mM to 0.1 mM, based on a total weight of the iron in first electrode. In an aspect, the sulfur may be included in both the alkaline electrolyte and the first electrode.

Mentioned is an aspect wherein the first electrode comprises the trivalent element and sulfur, preferably wherein the trivalent element is aluminum, and wherein preferably the sulfur is provided as a sulfide. In an aspect where the first electrode comprises sulfur, the aluminum may be present in the first electrode in an amount of 0.01 to 50 wt %, 0.05 to 40 wt %, 0.1 to 30 wt %, 0.5 to 25 wt %, 1 to 20 wt %, 2 to 15 wt %, 4 to 12 wt %, or 5 to 10 wt %, based on a total weight of the iron in the first electrode. As is further discussed above, and while not wanting to be bound by theory, it is understood that the trivalent element and the sulfur form a complex that results in improved mechanical stability of the electrode. The trivalent element and the sulfur may be provided in a same additive, e.g., as a compound that comprises the trivalent element and sulfur, such as aluminum sulfide. The trivalent element and the sulfur may be provided in distinct additives, e.g., as a first additive comprising the trivalent additive and a second additive comprising the sulfur. Use of an aluminate as a first additive and a sulfide as a second additive is mentioned.

The first electrode may further include the additive comprising tin. The tin may be provided in the iron electrode as tin metal, as a tin-containing compound, or a combination thereof. Exemplary tin species include tin metal, sodium stannate trihydrate (Na₂SnO₃ 3H₂O), sodium stannate (Na₂SnO₃), potassium stannate trihydrate (K₂SnO₃ 3H₂O), potassium stannate (K₂SnO₃), calcium stannate (CaSnO₃), magnesium stannate (MgSnO₃), barium stannate (BaSnO₃), cobalt stannate (Co₂SnO₄), tin (II) oxide (SnO), tin oxide (SnO₂), cylindrite (Pb₃Sn₄FeSb₂S₁₄), canfieldite (Ag₈SnS₆), copper iron tin sulfide (Cu₂FeSnS₄), a lead-tin alloy such as 60/40 Sn/Pb solder, a 63/37 Sn/Pb solder, a Terne I alloy comprising 10 to 20% Sn, with the balance being Pb, a zinc-tin alloy such as a Terne II alloy comprising 10 to 20% Sn, with the balance being Zn, or a tin sulfide such as SnS or SnS₂.

When present, an amount of tin or tin-containing compound in the first electrode may be greater than 0.01 wt %, based on a total weight of the iron in the first electrode. For example, the tin or tin-containing compound may be present in the first electrode in an amount of 0.01 to 40 wt %, 0.05 to 30 wt %, 0.1 to 25 wt %, 0.5 to 20 wt %, or 1 wt % to 15 wt %, based on a total weight of the iron in first electrode. In some embodiments, the tin or tin-containing compound may be present in the first electrode in an amount of 11 to 22 wt %, or 18 to 20 wt %, based on a total weight of the iron in the first electrode.

The trivalent element and the tin may be provided in the same additive, or as co-distinct additives, e.g., as a first additive comprising the trivalent additive and a second additive comprising the tin. Use of an aluminate as the first additive and potassium stannate as the second additive is mentioned.

As mentioned above, beneficial effects can be provided by use of the trivalent element, tin, and sulfur in combination. Mentioned is use of the trivalent element, tin additive, and sulfur, wherein a total content of the trivalent element, the tin, and the sulfur is greater than 0.01 wt %, preferably 0.01 to 20 wt %, based on a total weight of iron in the first electrode. The content of the trivalent element, the tin additive, and the sulfur may be present in the first electrode in an amount of 0.01 to 20 wt %, 0.05 to 15 wt %, 0.1 to 10 wt %, or 0.5 to 5 wt %, based on a total weight of the iron in first electrode. Mentioned is use of aluminum for the trivalent element, preferably an aluminate, and use of a stannate for the tin, preferably potassium stannate, and use of a sulfide for the sulfur, preferably zinc sulfide.

The first electrode may further include a conductive material. Materials that improve the conductivity of the iron electrode, such as a highly conductive metal or main group element, such as tin, carbon, copper, silver, gold, a derivative thereof, or a combination thereof, may be included in the iron electrode to improve charging of the iron electrode. A highly conductive metal may be a metal element that has an electrical resistivity below 125 nano ohm-meters (nΩ·m).

### Method of Manufacture of the Negative Electrode

Also disclosed is a method of manufacturing the negative electrode (e.g., iron electrode). The method comprises contacting iron and an additive that includes the trivalent element to provide an electrode composition; and disposing the electrode composition on a substrate, or extruding or pressing the electrode composition to manufacture the iron electrode. In an aspect, iron particles may be mixed with the additive and optionally a binder, and then extruded or pressed to provide the iron electrode. The electrode composition may optionally be disposed on the substrate to manufacture the iron electrode.

The iron electrode may be formed from a slurry, ink, suspension, or paste of iron-containing particles. In some embodiments, the iron electrode may be formed from pelletized, briquetted, pressed, powdered, and/or sintered iron-containing compounds or iron particles. The iron-containing compounds may include one or more forms of iron, ranging from highly reduced (i.e., metallic) iron to highly oxidized iron (having a higher average oxidation state). In some embodiments, the iron electrode may be sintered iron agglomerates. having various shapes. In some embodiments, atomized or sponge iron powders can be used as the feedstock material for forming sintered iron electrodes. For example, the iron electrode may include metallurgically-bonded sponge iron particles, such as direct reduced iron (DRI) or other sponge iron powder particles, wherein the microporosity with the sponge iron particles is greater than 50 vol % and the particle size of the sponge iron particles is greater than 100 micrometers.

The iron electrode may be formed from a slurry, or dough with appropriate additives, including those as described herein, and other components such as conductive fibers and binders, and pressed, extruded, tapecast, or otherwise processed into a suitable shape. A green body suitable for sintering to form an iron electrode may include a suitable iron-containing feedstock and may further include a binder, such as a polymer or inorganic clay-like material. In an embodiment, a sintered iron agglomerate in the form of a pellet may be formed in a furnace, such as a continuous feed calcining furnace, batch feed calcining furnace, shaft furnace, rotary calciner, or a rotary hearth. The pellet may include any suitable form of reduced and/or sintered iron precursor, such as DRI, sponge iron powder, or an oxidation or reduction product thereof. The pellet, such as a DRI pellet, may be treated using electrical, electrochemical, mechanical, chemical, or a thermal process to provide a pellet suitable for use in an electrode for an electrochemical cell. The iron electrode may be a pressed plate electrode, a coated electrode, a slip cast electrode, or any other manufacturing methods known in the art for the manufacture of secondary storage electrodes.

The additive may be incorporated into the iron electrode by contacting the additive with the iron feedstock (iron-containing feedstock), such as DRI or sponge iron, and the additive is mixed with the iron feedstock to provide a mixture suitable for pressing or sintering to provide an iron electrode. In an aspect, a cassiterite ore concentrate or other source of tin oxide, such as SnO₂, may be incorporated into an iron ore concentrate for use in making direct reduced iron (DRI) such that the cassiterite does not evaporate during the firing or calcining steps, and is then co-reduced with the iron oxides to yield a tin-containing sponge iron after the reduction process completes. In some embodiments, sodium, zinc, iron metal, tungsten, or manganese sulfide may be added to an iron oxide powder that is reduced to form an iron oxide sponge containing sodium sulfide, zinc sulfide, or manganese sulfide. In an aspect, materials containing multiple additive elements, e.g., cylindrite (PbSn₄FeSb₂S₁₄), or a combination of materials, may be incorporated into iron ore concentrate prior to reduction. In some embodiments, tin, aluminum, sulfur, or a combination thereof, may be incorporated into the iron ore concentrate prior to reduction.

### Negative Current Collector

The first electrode may further comprise a current collector, or may be on or directly on the current collector. The current collector may comprise any suitable metal or alloy, and may comprise iron, nickel, copper, stainless steel, nickel-plated stainless steel plate, or a combination thereof. The current collector may be porous or nonporous. In an aspect, the iron active material may be distinguished from current collector in that the iron active material has a greater microporosity than the current collector. In some embodiments, the current collector may be a mesh or perforated sheet having void dimensions (e.g., through holes) ranging from about 0.1 mm to about 10 mm, to facilitate electrolyte flow therethrough.

### Positive Electrode

The electrochemical cell, e.g., iron-air cell also includes a second electrode. The second electrode is a positive electrode, and may be a cathode on discharge. In an aspect, the second electrode is an air electrode. The air electrode may be an oxygen reduction reaction (ORR) electrode or an oxygen evolution reaction (OER) electrode. The second electrode may include an electroconductive material, and a suitable catalyst disposed on the electroconductive material. The electroconductive material may be a carbonaceous material, a perovskite-type conductive material, a porous conductive polymer, a porous metal, or a combination thereof. The carbonaceous material may have a porous structure, or may lack a porous structure. Specific examples of the carbonaceous material having a porous structure include, for example, mesoporous carbon. Exemplary carbonaceous material lacking a porous structure include graphite, acetylene black, carbon nanotube, carbon fiber, or the like, or a combination thereof.

A catalyst may be disposed on the electroconductive material to form a positive electrode catalyst layer (e.g., an air electrode catalyst layer). The catalyst may include a platinum-group metal such as nickel, palladium, or platinum; a perovskite-type oxide that has a transition metal such as cobalt, manganese, or iron; an inorganic compound that is a noble metal oxide such as an oxide of ruthenium, iridium, or palladium; a metal coordination organic compound having a porphyrin skeleton or a phthalocyanine skeleton; or a manganese oxide or a cobalt oxide, such as La_{0.7}Sr_{0.3}CoO₃. In some embodiments, the catalyst may be a layered double hydroxide represented by formula [M²⁺₁₋ₓM³⁺ₓ(OH)₂][Aⁿ⁻_{x/n}·yH₂O], where x is a real number that satisfies 0<x<1; y is a real number; M²⁺ is a divalent metal ion such as Mg²⁺, Fe²⁺, Zn²⁺, Ca²⁺, Li²⁺, Ni²⁺, Co²⁺ or Cu²⁺; M³⁺ is a trivalent metal ion such as Al³⁺, Fe³⁺, Mn³⁺ or Co³⁺; and Aⁿ⁻ is a counter anion such as a nitrate ion, a carbonate ion, or a chloride ion. The catalyst may be disposed on the electroconductive material with a binder. Suitable binders include polyvinylidene fluoride (PVDF), polytetrafluoroethylene (PTFE), an elastomeric resin such as styrene butadiene rubber (SBR rubber), or the like, or a combination thereof. A content of the binder in the air electrode catalyst layer is not particularly limited, and may be, for example, no greater than 30 wt %, or 1 wt % to 20 wt %, or 2 wt % to 10 wt %, based on a total weight of the air electrode catalyst layer. The catalyst layer may have a thickness of 0.5 micrometers (μm) to 500 μm, or from 1 μm to 200 μm.

When the second electrode is an OER electrode, it may be permeable to the alkaline electrolyte. For example, the second electrode may be formed from a porous metal sheet or mesh. In some embodiments, the second electrode may preferably be formed of a nickel mesh or a nickel-plated steel mesh. The OER electrode may include an oxygen evolution catalyst. For example, in some embodiments, the OER electrode may include a porous metal mesh and an oxygen evolution catalyst. Exemplary oxygen evolution catalysts may include nickel, alloys of nickel with iron, manganese oxide, iron, nickel oxide (NiOₓ), nickel oxyhydroxide (NiOₓ (OH)_{y}), iron oxide, (FeOₓ), iron oxyhydroxide (FeOₓ(OH)_{y}), or the like, or a combination thereof.

When the second electrode is an ORR electrode, it is permeable to oxygen. The ORR electrode may include a conductive gas diffusion electrode (GDE) catalyst, including carbon, manganese oxide, silver, platinum, nickel foam, a nickel mesh, or the like, or a combination thereof, and may also include a hydrophobic material, such as polytetrafluoroethylene (PTFE). For example, the ORR electrode may include a hydrophilic region and a hydrophobic region. The hydrophobic region may be exposed to air and the hydrophilic region may be exposed to the alkaline electrolyte.

The second electrode may further include a gas diffusion material to facilitate transport of oxygen or air to the catalyst, during discharge, or facilitating oxygen generated during charge to diffuse towards the exterior. At the same time, a gas diffusion layer comprising the gas diffusion material may function as a current collector and support of the air electrode catalyst layer. The gas diffusion layer may include carbon, a metal, a conductive ceramic, or the like, or a combination thereof. In some embodiments, the gas diffusion material may be a porous conductive sheet including carbon. The gas diffusion layer may be a woven or non-woven carbon material, such as carbon paper, or a woven or non-woven metal mesh, such as an expanded metal material.

### Positive Current Collector

The positive electrode, i.e., air electrode, may be provided with a separate current collector that collects charge where the gas diffusion material does not function as current collector. The material of the current collector is not particularly limited, provided that the material has suitable conductivity. Examples include stainless steel, nickel, aluminum, iron, titanium, or carbon. The current collector may have any suitable shape, and may be a foil, plate, or mesh. For example, the current collector may be in the form of a metal plate, and may comprise iron, nickel, stainless steel, nickel-plated stainless steel plate, or the like. Use of an expanded metal mesh is mentioned. The current collector may be disposed so as to be in contact with the gas diffusion layer or the air electrode catalyst layer. The air electrode catalyst layer may be on the gas diffusion layer. The thickness of the current collector may be 10 μm to 1000 μm, or 20 μm to 400 μm. The current collector may be porous or nonporous. In some embodiments, the current collector may be a perforated sheet having void dimensions (e.g., through holes) ranging from 0.1 millimeter (mm) to 10 mm, to facilitate electrolyte flow therethrough.

### Electrochemical Cell

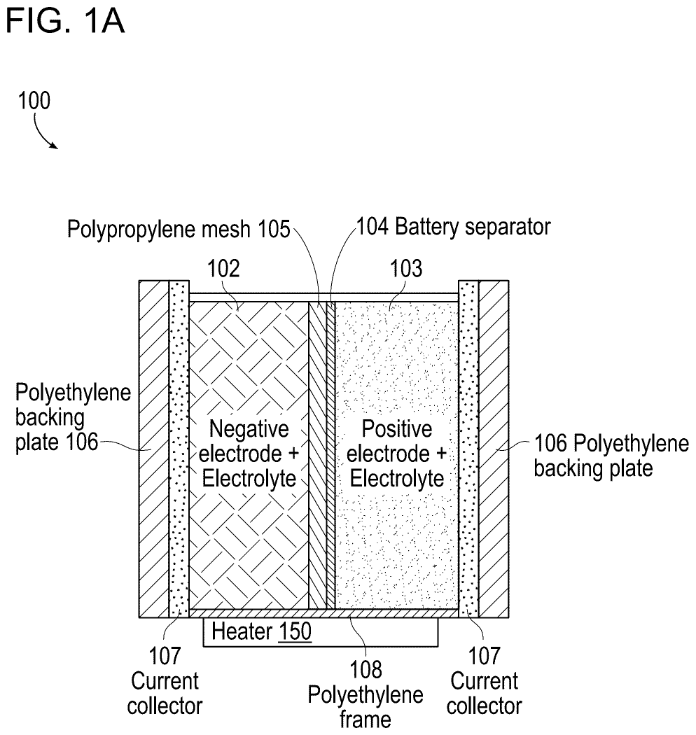

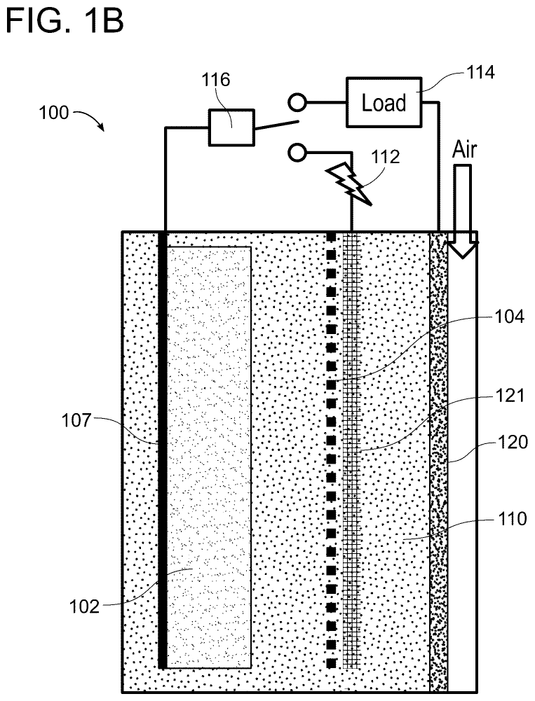

An electrochemical cell such as an iron-air cell is shown schematically in FIG. 1A. As shown in FIG. 1A, the electrochemical cell 100 includes a negative electrode region 102 including a negative electrode, a positive electrode region 103 including a positive electrode, an alkaline electrolyte (shown disposed in the negative electrode region 102 and the positive electrode region 103), and optionally a separator 104 disposed between the positive electrode region 102 and the negative electrode region 103. FIG. 1A schematically illustrates the electrochemical cell 100, including a negative electrode and the alkaline electrolyte 102 separated from a positive electrode and the alkaline electrolyte 103 by the optional separator 104. The separator 104 may be supported by a polypropylene mesh 105 and a polyethylene frame 108 of the cell 100. Current collectors 107 may be associated with respective ones of the negative electrode 102 and positive electrode 103, and supported by polyethylene backing plates 106.

The temperature of the electrochemical cell 100 may be controlled, such as by insulation around the cell 100 and/or a heater 150. For example, the heater 150 may raise the temperature of the cell 100 and/or specific components of the cell, such as the alkaline electrolyte 102, 103. The configuration of the electrochemical cell 100 in FIG. 1A is merely an example of an electrochemical cell configuration and is not intended to be limiting. Other configurations, such as electrochemical cells with different type meshes and/or without the polypropylene mesh 105, electrochemical cells with different type frames and/or without the polyethylene frame 108, electrochemical cells with different type current collectors and/or without the current collectors, electrochemical cells with different type backing plates and/or without the polyethylene backing plates 106, electrochemical cells with different type insulation and/or without insulation, and/or electrochemical cells with different type heaters and/or without a heater 150, mentioned in addition to the configuration shown in FIG. 1A.

An optional separator may be further included between the first electrode and the second electrode. The separator may be a passive separator, such as conventional diaphragm separators, or may be an active separator, such as ion exchange membranes. In some embodiments, a separator may be chosen based on an ability to allow selective transfer of desired molecules or materials while substantially limiting or preventing transfer of undesired molecules or materials. For example, some separator membranes are ion-selective and allow the transfer of negative (or positive) ions while substantially preventing transfer of positive (or negative) ions. In other examples, separator materials may be chosen based on an ability to allow or prevent the cross-over of gas bubbles from one side (associated with one electrode) to the opposite side (associated with the counter-electrode).

The separator, if present, may comprise a dielectric material, and may be a porous material. In an aspect, the separator is permeable to positive ions, such as Fe²⁺, Fe³⁺, K⁺, Na⁺, Cs⁺, and/or NH⁴⁺ ions, or the like, or a combination thereof. In an aspect, the separator is porous to negative ions, such as hydroxide ions, or the like. The separator may be impermeable or effectively impermeable to active materials of the catholyte and anolyte. In some embodiments, the separator may be a membrane, such as a membrane formed from a polymer with a tetrafluoroethylene backbone and side chains of perfluorovinyl ether groups terminated with sulfonate groups (e.g., a sulfonated tetrafluoroethylene membrane, a membrane made of polymers sold under the Nafion brand name, etc.), or the like.

The separator, if present, may include an anion exchange membrane (AEM), a cation exchange membrane (CEM), a zwitterionic membrane, a porous membrane having an average pore diameter of less than 10 nanometers, a polybenzimidazole-containing membrane, a polysulfone-containing membrane, polycarboxylic-containing membrane, a polyetherketone-containing membrane, a membrane including polymer(s) of intrinsic microporosity (PIM), or the like, or a combination thereof. Preferably, the separator includes an anion exchange membrane (AEM) or a cation exchange membrane (CEM). In some embodiments, the separator may include a composite membrane including an inorganic material and an organic material. In some embodiments, the inorganic material may include a metal oxide or a ceramic material. In some embodiments, the organic material may include a polyether ether ketone (PEEK), a polysulfone, a polystyrene, a polypropylene, a polyethylene, or the like, or a combination thereof.

The separator, if present, may provide a physical barrier between the first electrode and the second electrode. For example, the separator may include a porous polyolefin film, a glass fiber mat, a cotton fabric, a rayon fabric, cellulose acetate, paper, or the like, or a combination thereof. In some embodiments, the separator may be a dielectric structure or frame, a ribbed structure, or a porous insulator. In some embodiments, the separator may include a porous frame configured to compress the iron electrode.

In an aspect, the positive electrode may comprise an oxygen evolution reaction (OER) electrode comprising an OER catalyst, and an oxygen reduction reaction (ORR) electrode (e.g., a gas diffusion electrode) comprising an ORR catalyst. Mentioned is an aspect in which oxygen is the reactant at the positive electrode where it can be advantageous to have separate ORR and OER electrodes for discharge and for charge. A switchable component, e.g., a relay, may be present that switches between the OER electrode, which is used on charge, and the ORR electrode for discharge, respectively. Referring to FIG. 1B, an iron-air cell 100 is provided. The iron-air cell 100 includes a current collector 107, a negative electrode 102 (anode on discharge) disposed on the current collector 107, an ORR electrode 120, and an OER electrode 121.

The iron-air cell 100 may further include a separator 104 that is disposed between the negative electrode 102 and the OER electrode 121. The separator 104 may include a compression frame, a porous insulator, and/or a ribbed structure to facilitate bubble egress from the negative electrode 102. For example, the separator 104 may be a porous dielectric coating formed on the negative electrode 102 and/or the OER electrode 121. The iron-air electrochemical cell further includes an electrolyte 110 that is in contact with the negative electrode 102, a first surface of the ORR electrode 120, and the OER electrode 121. Suitable electrolytes are further described herein.

During charge of the iron-air cell 100, the OER electrode 121 and the negative electrode 102 may be electrically connected to a power source 112, such that iron species of the negative electrode 102 are reduced to form metallic iron, i.e., Fe(0). During discharge of the iron-air cell 100, the ORR electrode 120 and the negative electrode 102 may be electrically connected to a load 114, such that metallic iron Fe(0) of the negative electrode 102 is oxidized to form an oxidized iron species such as Fe₃O₄. The iron-air electrochemical cell 100 may be further configured to include a switch 116 (e.g., a relay) to allow electrical connection between the negative electrode 102 and the power source 112, or to allow electrical connection between the negative electrode 102 and the load 114.

The disclosed iron-air cell may provide improved performance. For example, the iron-air cell may have one or more of an improved coulombic efficiency, an improved energy efficiency, an improved voltaic efficiency, an improved specific discharge capacity, a reduced hydrogen evolution, or a combination thereof, relative to a same iron-air cell without the additive that includes a trivalent element.

In some embodiments, the iron-air cell may have a coulombic efficiency of at least 37%, such as 37% to 300%, preferably 37% to 200%, greater than a coulombic efficiency of a same iron-air cell without the additive including the trivalent element. For example, the iron-air cell may have a coulombic efficiency at least 58% greater than a coulombic efficiency of a same iron-air cell without the additive including the trivalent element, such as 58% to 300%, preferably 60% to 200% greater than a coulombic efficiency of a same iron-air cell without the additive including the trivalent element.

In some embodiments, the iron-air cell has an energy efficiency that is at least 47%, such as 47% to 300%, preferably 47% to 200%, greater than an energy efficiency of a same iron-air cell without the additive including the trivalent element.

In some embodiments, the iron-air cell may have a voltaic efficiency that is at least 5%, such as 5% to 20%, preferably 7% to 15%, greater than a voltaic efficiency of a same iron-air cell without the additive including the trivalent element.

In some embodiments, the iron-air cell may have a specific discharge capacity that is at least 35%, such as 35% to 300%, preferably 35% to 200%, greater than a specific discharge capacity of a same iron-air cell without the additive comprising the trivalent element.

In some embodiments, the iron-air cell may have a hydrogen evolution amount that is less than a hydrogen evolution amount of a same iron-air cell without the trivalent element. In some embodiments, the iron-air cell may have a hydrogen evolution rate that is less than a hydrogen evolution rate of a same iron-air cell without the additive comprising the trivalent element.

Use of the additive also may enhance rate capability. For example, at a rate greater than 5 mA/cm², such as 5 to 50 mA/cm², 10 to 45 mA/cm², 15 to 40 mA/cm², or 20 to 35 mA/cm², a cell comprising the additive as disclose herein may provide improved throughput or specific energy, such as a cumulative discharge throughput of 0 to 50 ampere-hours per gram (Ah/g), 1 to 25 Ah/g, 2 to 20 Ah/g, 3 to 15 Ah/g, or 4 to 8 Ah/g.

In an aspect wherein the alkaline electrolyte includes the additive including the trivalent element, and the alkaline electrolyte further optionally includes tin, or tin and sulfur, the iron-air cell may have one or more of an improved coulombic efficiency, an improved energy efficiency, an improved voltaic efficiency, an improved specific discharge capacity, a reduced hydrogen evolution, or a combination thereof, relative to a same iron-air cell without the additive.

In an aspect, while not wanting to be bound by theory, when the alkaline electrolyte includes the additive including the trivalent element (e.g., aluminum), tin, and sulfur, the interaction between aluminum and sulfur, or aluminum, sulfur, and tin may provide increased discharge capacity. Further, also while not wanting to be bound by theory, the addition of sulfur in the cell (e.g., in the electrolyte, negative electrode, or both) including aluminum, or aluminum and tin, may contribute to an enhanced rate capability of the negative electrode. In an aspect, the enhanced rate capability may be observed at a temperature range of 10 to 75° C., e.g., 30° C.

In an aspect, when discharged at 30° C. from 0.85 V to 0.65 V at a current of 20.5 mA/g, the electrode provides at least 300 mAh/g. In an aspect, when discharged at 45° C. from 0.85V to 0.65V at a current of 20.5 mA/g, the electrode provides at least 250 mAh/g.

In an aspect, an iron-air battery comprises: a plurality of the iron-air cells, wherein the iron-air cells are connected in series, parallel, or a combination thereof.

### Method of Manufacturing the Electrolyte

Disclosed is a method of manufacturing the alkaline electrolyte for an iron-air battery, wherein the alkaline electrolyte includes an alkaline solution having a total hydroxide concentration of greater than 1 M, based on a total volume of the alkaline electrolyte; and 1 mM to 5 M of the additive, based on a total volume of the alkaline electrolyte. The additive includes the trivalent element and may further include tin, sulfur, or a combination thereof. Use of aluminum as the trivalent element is mentioned.

The method of preparing the alkaline electrolyte may comprise providing an alkaline solution having a total hydroxide concentration of greater than 1 M, based on a total volume of the alkaline electrolyte; providing a source of the trivalent element, such as a metal, an oxyanion, an oxide, a hydroxide, or a combination thereof comprising the trivalent element; and contacting the alkaline solution with the source to prepare the alkaline electrolyte.

Providing the alkaline solution may comprise contacting water and a suitable hydroxide source to provide the alkaline solution. The contacting may include mixing or stirring. As provided herein, the hydroxide source may include KOH, NaOH, LiOH, RbOH, CsOH, FrOH, Be(OH)₂, Ca(OH)₂, Mg(OH)₂, Sr(OH)₂, Ra(OH)₂, Ba(OH)₂, or a combination thereof. In some embodiments, the alkaline solution may be prepared using lithium hydroxide, potassium hydroxide, sodium hydroxide, or a combination thereof. For example, the alkaline solution may include potassium hydroxide with a lesser amount of sodium hydroxide or lithium hydroxide. Contacting water and the hydroxide source may release heat, which can aid in the dissolution of further additives. Sulfur may optionally be provided in the alkaline electrolyte by contacting the alkaline solution with a sulfide. The sulfide can be added after the addition of at least a portion of the hydroxide source to reduce the formation of hydrogen sulfide gas. Also additional additives may be further added to the alkaline electrolyte at any suitable stage in the method.

The additive including the trivalent element and optionally tin and sulfur may be provided in any suitable form. Mentioned is use of a metal, an oxyanion, an oxide, a hydroxide, or a combination thereof comprising the trivalent element and optionally tin and sulfur. In some embodiments, the alkaline solution may be contacted with a metal or metalloid of the trivalent element, specifically the elemental form of aluminum, scandium, yttrium, or boron, or a combination thereof. In an aspect, the alkaline solution may be contacted with aluminum metal to provide the alkaline electrolyte comprising aluminum. The metal or metalloid of the trivalent element may be in any suitable form, and may be in the form of a rod, spherical particle, platelet, chip, or a combination thereof. Use of aluminum metal platelets is mentioned. To enable the use of aluminum metal, an appropriate quantity of excess hydroxide may be used to minimize the loss of alkalinity in the final product. Additionally, when using aluminum metal to provide the additive in an alkaline electrolyte, the production of hydrogen gas occurs, which may be vented or collected for other uses.

Mentioned is use of an oxyanion for the additive comprising the trivalent element. An oxyanion is an anion including oxygen and the trivalent element. Exemplary oxyanions include aluminate. Aluminate may be provided as potassium aluminate (KAlO₂) or sodium aluminate (NaAlO₂), which provide Al(OH)₄ in an aqueous alkaline solution. The trivalent element of the additive may be provided as a borate oxyanion, e.g., orthoborate BO₃³⁻, metaborate BO₂, tetraborate B₄O₇²⁻, or a combination thereof. Disclosed is the use of potassium tetrahydroxyborate (K[B(OH)₄]) or sodium tetrahydroxyborate (Na[B(OH)₄]) to provide tetrahydroxyborate, [B(OH)₄], tripotassium orthoborate (K₃[BO₃]), or trisodium orthoborate, (Na₃[BO₃]) to provide orthoborate, [BO₃]³⁻, sodium metaborate (Na₃[B₃O₆]) to provide [BO₂] or the cyclic trimer [B₃O₆]³⁻, or sodium tetraborate (Na₂[B₄O₇]) to provide [B₄O₇]²⁻. The borate oxyanion may be provided in an anhydrous form or a hydrated form prior to contact with water or the alkaline solution to provide the alkaline electrolyte. The oxyanion may be provided in an anhydrous form or a hydrated form prior to contact with water or the alkaline solution to provide the alkaline electrolyte.

The trivalent element may be provided as an oxide of the trivalent element. Exemplary oxides of the trivalent element include aluminum oxide (Al₂O₃), scandium (III) oxide (Sc₂O₃), yttrium oxide (Y₂O₃), or a combination thereof. The oxide of the trivalent element may be provided in an anhydrous form or a hydrated form prior to contact with water or the alkaline solution to provide the alkaline electrolyte.

The trivalent element may be provided as a hydroxide of the trivalent element. Exemplary hydroxides include aluminum hydroxide (Al(OH)₃), scandium (III) hydroxide (Sc(OH)₃), yttrium hydroxide (Y(OH)₃), or boric acid, such as orthoboric acid (B(OH)₃), metaboric acid (HBO₂), or tetraboric acid (H₂B₄O₇). The hydroxide of the trivalent element may be provided in an anhydrous form or hydrated form prior to contact with water or the alkaline solution to provide the alkaline electrolyte.

Also disclosed is use of a compound containing a plurality of the trivalent element, such as potassium aluminum borate (K₂Al₂B₂O₇), or calcium aluminum triborate (Ca[AlB₃O₇]) in the alkaline electrolyte. Such compounds including the trivalent element may be provided in an anhydrous form or hydrated form prior to contact with water or the alkaline solution to provide the alkaline electrolyte.

The method may further include contacting the alkaline solution, the alkaline electrolyte, or the water with an additional additive as described herein.

### Method of Manufacturing the Electrochemical Cell

Also disclosed is a method of manufacturing an electrochemical cell such as an iron-air cell. The method includes providing a cell stack that includes a first electrode (e.g., a negative electrode) and a second electrode (e.g., a positive electrode). The second electrode may be adjacent (e.g., opposite) the first electrode, and optionally a separator may be disposed between the first electrode and the second electrode. The first electrode may comprise the additive. The cell stack may be contacted with an alkaline electrolyte that includes the additive to manufacture the iron-air cell. A concentration of the additive may be greater than 1 mM, preferably 1 mM to 5 M, or more preferably between 25 mM and 150 mM, based on a total volume of the electrolyte. In some embodiments, the additive(s) included in the alkaline electrolyte comprises the trivalent additive and tin. In some embodiments, the additive(s) included in the alkaline electrolyte comprises the trivalent element and sulfur, or the trivalent element, tin, and sulfur.

### Method of Manufacturing a Battery

Also provided is a method of manufacturing a battery, e.g., an iron-air battery, where the method includes providing a plurality of the electrochemical cells (e.g., iron-air cells), and connecting the iron-air cells in any suitable combination of series or parallel connections to manufacture the iron-air battery.

### Method of Operation

Also provided is a method of operating the electrochemical cell such as the iron-air cell, or the battery such as the iron-air battery as disclosed herein. The method of operating the iron-air cell may include treating, for example heating or cooling, the iron-air cell to an operation temperature, wherein the operation temperature is 0° C. to 75° C., 25° C. to 55° C., or 25° C. to 45° C.; and discharging the iron-air cell to operate the iron-air cell. A discharged product may comprise Fe₃₋ₓSnₓO₄, 0≤x<1, optionally 0<x<1, or Fe₃O₄. In an aspect, x of Fe₃₋ₓMₓO₄ may be 0.001≤x≤0.5, 0.05≤x≤0.3, or 0.01≤x<0.1. The Fe₃₋ₓSnₓO₄ can be any suitable phase.

### EXAMPLES

### Example 1, Comparative Example 1, and Comparative Example 2. Cycling of Subscale Cells

Subscale cells were prepared each having a sintered sponge iron negative electrode with 5 wt % zinc sulfide as an additive, a positive electrode including a nickel mesh oxygen evolution electrode and a gas diffusion electrode, a relay that switches between them for charge and discharge, and an alkaline electrolyte. The electrolyte for Comparative Example 1 contained 6.5 M potassium hydroxide (KOH). The electrolyte for Example 1 was the same as Comparative Example 1, except that it further included 150 mM sodium aluminate. The electrolyte for Comparative Example 2 was the same as Comparative Example 1, except that it further included 60 mM sodium stannate. The cells were operated at 45° C.

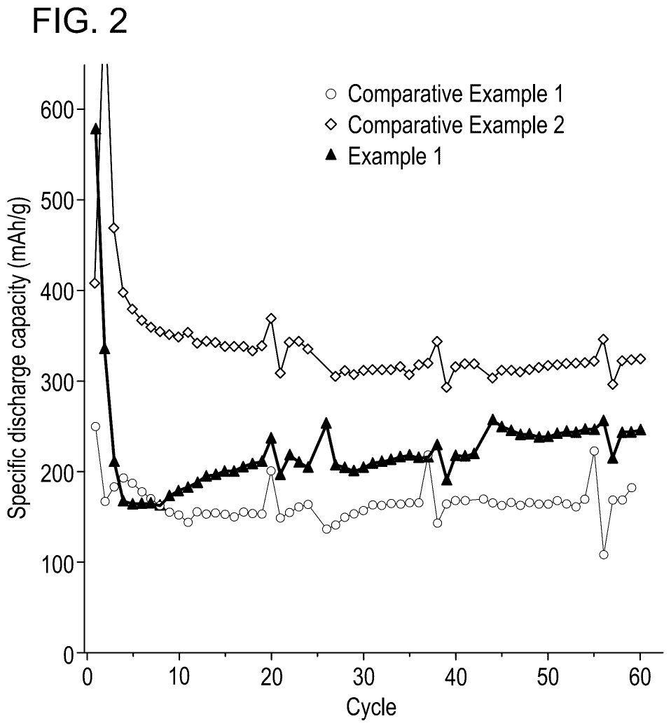

Duplicate identical cells were prepared and cycled at a discharge rate of 7.4 mA/cm², and a charge rate of 12.3 mA/cm². The charge capacity was 435 mAh/g. The specific discharge capacities of Example 1, Comparative Example 1, and Comparative Example 2 for 60 charge/discharge cycles are shown in FIG. 2. As shown in FIG. 2, the discharge capacity of the cells of Example 1, with 150 mM sodium aluminate, was greater than that of the cells of Comparative Example 1. The discharge capacity of the cells of Comparative Example 2, with 60 mM sodium stannate, was greater than the discharge capacities of Example 1 and Comparative Example 1.

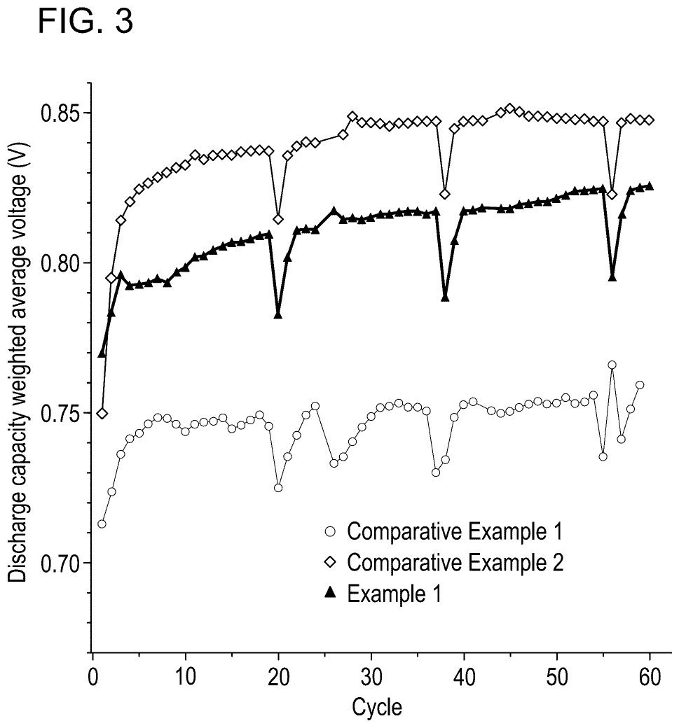

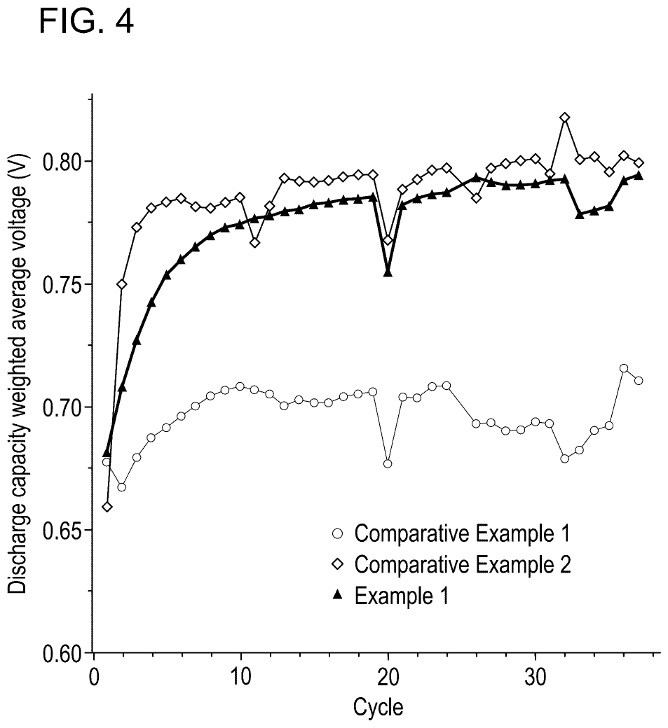

FIG. 4 shows the discharge-capacity-weighted average voltage for the cells of Example 1, Comparative Example 1, and Comparative Example 2 over multiple cycles operated at 30° C. The discharge-capacity-weighted average voltage was determined by dividing discharge energy, calculated by the integral of the discharge cell voltage over capacity, by the total discharge capacity for a particular cycle. It is noted that at 30° C., Example 1 showed increased discharge capacity weighted average voltage closer to the performance of Comparative Example 2, compared to the discharge capacity weighted average voltage at 45° C. as in FIG. 3.

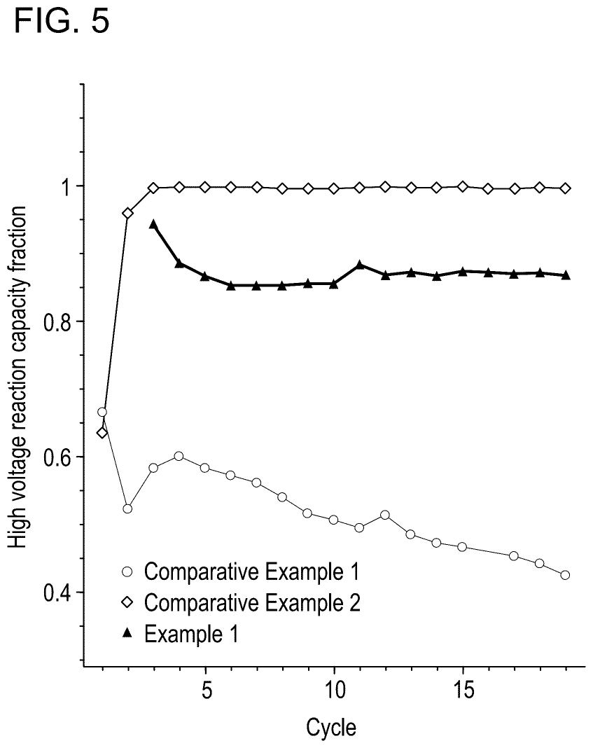

FIG. 5 is a graph of high voltage reaction capacity fraction versus cycle number for the cells of Example 1, Comparative Example 1, and Comparative Example 2 showing the fraction of discharge capacity accessed from a high voltage reaction. The high voltage reaction herein corresponds to a combination of reactions of Fe+2OH⁻⇄Fe(OH)₂+2e⁻ (Equation 1) and 3Fe(OH)₂+2OH⁻⇄Fe₃O₄+4H₂O+2e⁻ (Equation 2). The high voltage capacity fraction was determined by dividing the discharge capacity associated with a high voltage plateau by the total discharge capacity for a given cycle. The cell including the additive, sodium aluminate, shows an increased fraction of discharge capacity accessed from the high voltage reaction relative to the cell without the additive. The cell including sodium aluminate, however, does not meet or exceed the performance of the cell including sodium stannate (Comparative Example 2). While not wanting to be bound by theory, it is understood that the high voltage plateau, also referred to as a first discharge plateau, corresponds to a region of the discharge capacity attributed to the combination of reactions of Equation 1 and Equation 2 (i.e., high voltage reaction), in a graph of potential (V) vs. capacity (Q). In an aspect, the potential range of the first discharge plateau may be determined from a peak in a graph of differential capacity (dQ/dV) versus potential (V). The potential range of the first discharge plateau may correspond to the first peak (i.e., the most negative Fe peak) in the graph of dQ/dV versus V with capacity in excess of 50 mAh/g and below −0.9 V vs. a mercury-mercuric oxide (MMO) electrode. This potential range can be used to determine the region of the discharge capacity corresponding to the first discharge plateau in the graph of voltage versus specific capacity.

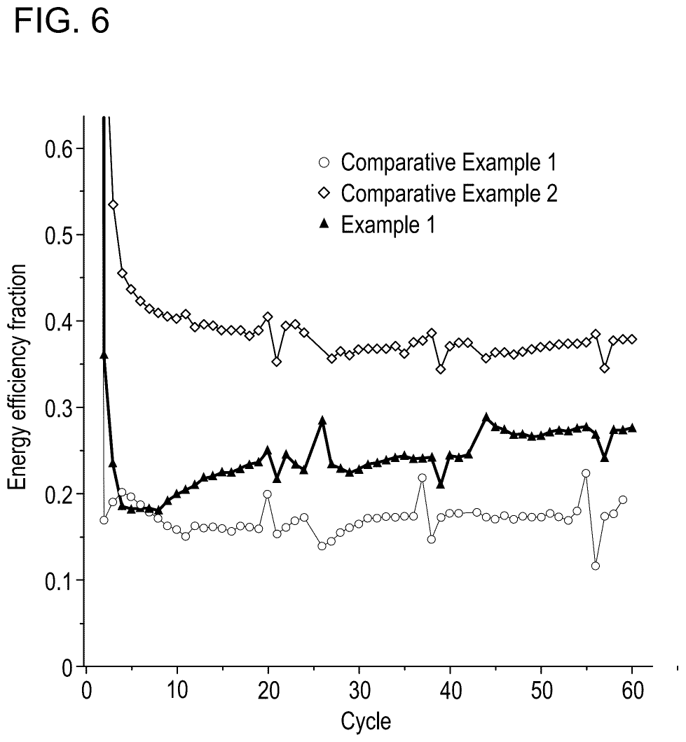

FIG. 6 shows a graph of energy efficiency fraction versus cycle number for the cells of Example 1, Comparative Example 1, and Comparative Example 2. The cell including the additive, sodium aluminate, shows increased energy efficiency fraction relative to the cell without the additive. The cell including the additive, sodium aluminate however, does not meet or exceed the performance of the cell including sodium stannate (Comparative Example 2).

### Example 2. Cycling of Subscale Cells

Subscale cells were prepared each having a sintered sponge iron negative electrode with 5 wt % zinc sulfide as an additive, a positive electrode including a nickel mesh oxygen evolution electrode and a gas diffusion electrode, a relay that switches between then for charge and discharge, and an alkaline electrolyte. The electrolyte for Example 2 contained 6.5 M potassium hydroxide (KOH), 75 mM sodium aluminate, and 30 mM sodium stannate. The cells were operated at 45° C.

Duplicate identical cells were prepared and cycled at a discharge rate of 7.4 mA/cm², and a charge rate of 12.3 mA/cm². The charge capacity was 435 mAh/g. The specific discharge capacities of Example 1, Comparative Example 1, and Comparative Example 2, and Example 2 are provided in FIG. 7.

Surprisingly and unexpectedly, Example 2 which includes both sodium aluminate (75 mM) and sodium stannate (30 mM) resulted in greater discharge capacity even at lower sodium stannate concentration in comparison with Comparative Example 2 including 60 mM of sodium stannate.

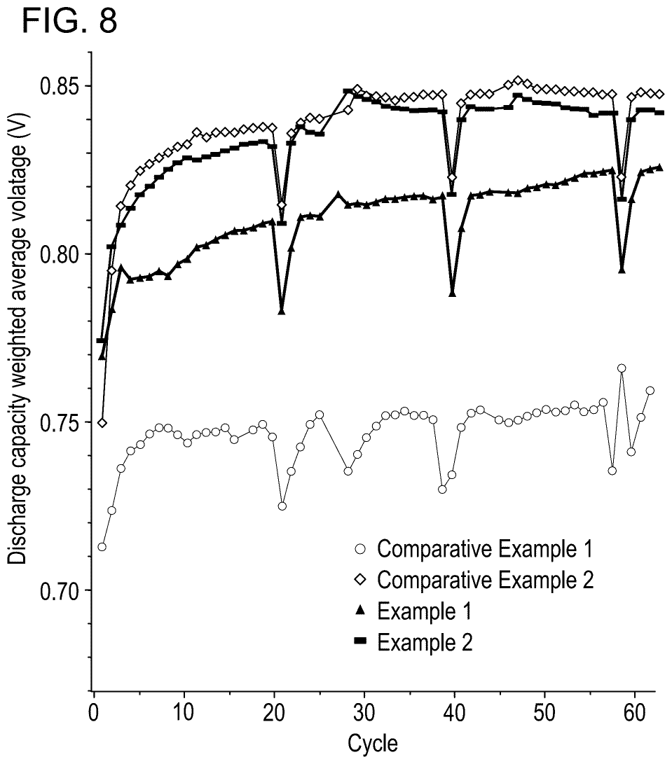

FIG. 8 is a graph of discharge capacity weighted average voltage (V) versus cycle number for the cells of Example 1, Comparative Example 1, and Comparative Example 2, and Example 2. It can be seen from FIG. 8 that the discharge voltage profile of Example 2 (including aluminate and stannate) matches with that of Comparative Example 1 (including stannate).

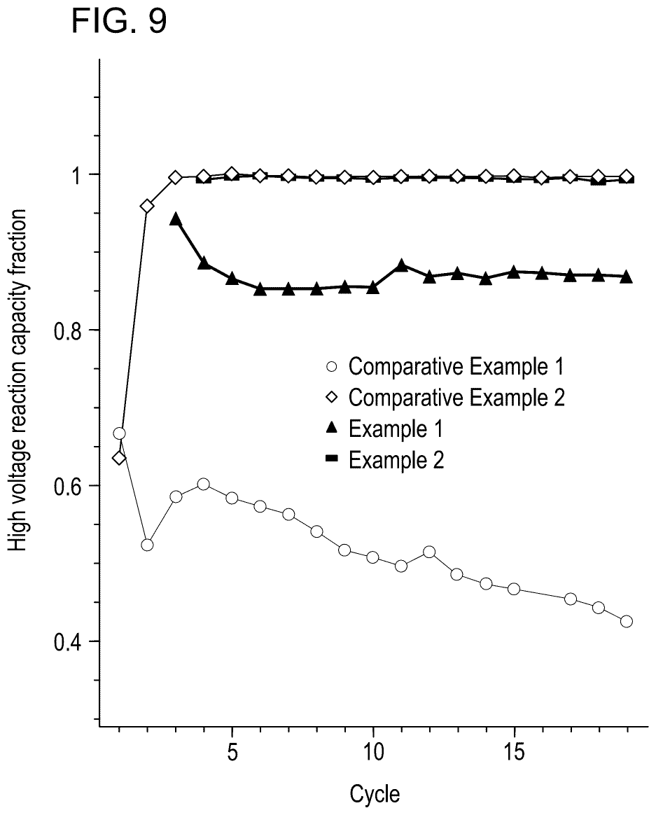

FIG. 9 is a graph of high voltage reaction capacity fraction versus cycle number for the cells of Example 1, Comparative Example 1, and Comparative Example 2 and Example 2 showing the fraction of discharge capacity accessed from the high voltage reaction relative to the Comparative Example 1.

Example 2 including both aluminate and stannate resulted in all specific discharge capacity being derived from the high voltage reaction (i.e., Equation 1 and Equation 2) alone with a decreased stannate concentration.

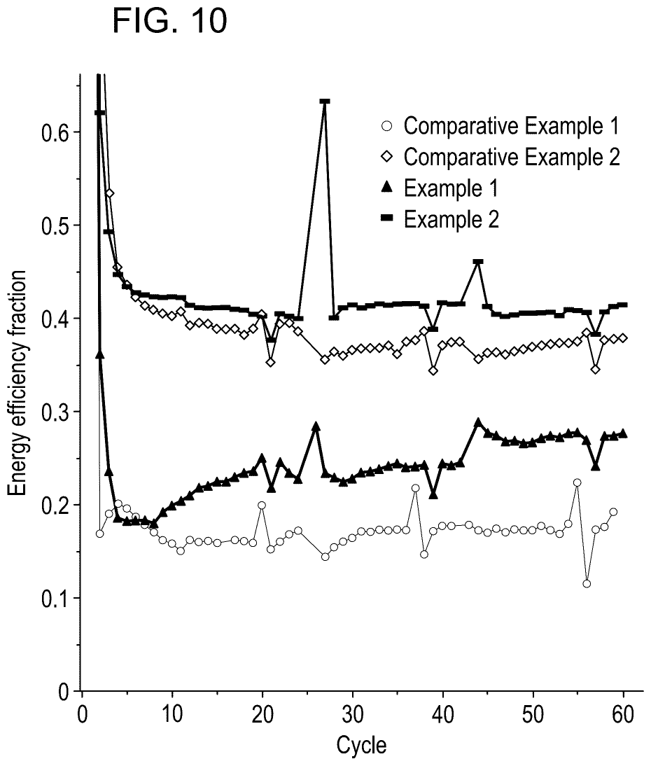

FIG. 10 shows a graph of energy efficiency fraction versus cycle number for the cells of Example 1, Comparative Example 1, and Comparative Example 2, and Example 2. As shown in FIG. 10, Example 2 including aluminate and stannate resulted in greater energy efficiency than Example 2 including aluminate alone, or Comparative Example 2 including stannate alone.

### Example 3. Addition of 5 mM Sodium Sulfide to Cells Including 60 mM Sodium Stannate, 125 mM Sodium Aluminate, and 5 wt % Zinc Sulfide

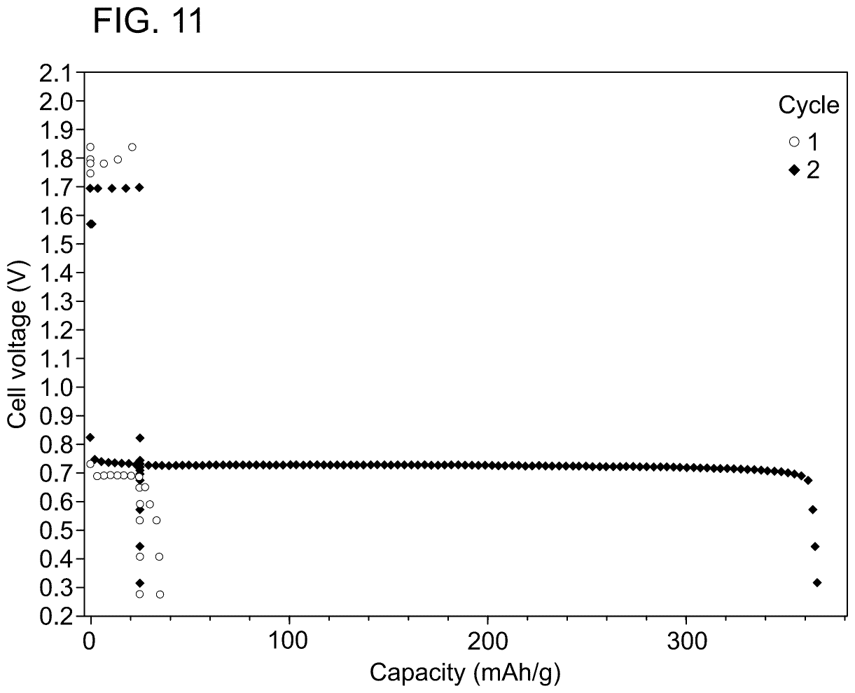

Subscale cells of Example 3 were prepared each having a sintered, sponge iron negative electrode with 5 wt % zinc sulfide as an additive, a positive electrode comprising a nickel mesh oxygen evolution electrode and a gas diffusion electrode, and an alkaline electrolyte. The electrolyte contained 6.5 M potassium hydroxide (KOH), 60 mM sodium stannate, and 125 mM sodium aluminate. The charge capacity for cycle 1 and 2 was 25 mAh/g, and the cells were cycled at a discharge rate of 12.3 mA/cm² and a charge rate of 26 mA/cm². The cell was operated at 30° C. FIG. 11 provides a graph of cell voltage (V) versus specific discharge capacity (mAh/g) for the cell of Example 3.

FIG. 11 shows the specific discharge capacity of the cell on cycle 1. The cell in this example was cycled at a greater discharge rate of 12.3 mA/cm² compared to the discharge rate of 7.4 mA/cm² for Example 2. Following the addition of 5 mM sodium sulfide at the end of discharge cycle 1, surprisingly, the specific discharge capacity increased 8-fold indicating a potential interaction between aluminum and sulfur, or aluminum, sulfur, and tin, depending on the discharge rate of the cell Thus, an improvement in the low temperature (e.g., 30° C.) rate capability of a negative electrode including aluminate can be achieved by increasing the sulfide concentration in the cell. While not wanting to be bound by theory, it is believed that slow sulfide transport, relative to the faster transport rate of the trivalent ion, can limit rate capability and appear as reduced discharge capacity at greater discharge rates. The discharge capacity can be unexpectedly increased by including a greater concentration of sulfide to compensate for the slow sulfide transport. Also unexpectedly, the preferred content of sulfide depended on the presence and/or the content of other additives such as aluminum and tin, and the discharge rate of the cell. In an aspect, the preferred content of sulfide was related to the presence of aluminum and tin together, and the preferred sulfide content for a cell including aluminum and tin together may be greater than the preferred sulfide content for a cell including aluminum alone, or tin alone. As noted above, in the absence of sulfide, an electrochemical cell comprising an iron negative electrode may not cycle.

### The Disclosed Subject Matter Further Encompasses the Following Aspects.

Aspect 1. An alkaline electrolyte comprising: an alkaline solution having a total hydroxide concentration of greater than 1 molar, based on a total volume of the alkaline electrolyte; an additive comprising a trivalent element, wherein a concentration of the trivalent element is 1 millimolar to 5 molar, based on a total volume of the alkaline electrolyte; sulfur; and tin.
Aspect 2. An alkaline electrolyte comprising: an alkaline solution having a total hydroxide concentration of greater than 1 molar, based on a total volume of the alkaline electrolyte; a trivalent element, wherein a concentration of the trivalent element is 10 to 250 millimolar, preferably 20 to 200 millimolar, or 1 to 5 molar, preferably 2 to 3 molar, based on a total volume of the alkaline electrolyte; tin; and sulfur, wherein a concentration of the sulfur is 0.01 to 500 millimolar, based on the total volume of the alkaline electrolyte.
Aspect 3. An alkaline electrolyte for an iron-air battery, the electrolyte comprising: an alkaline solution having a total hydroxide concentration of greater than 1 molar, based on a total volume of the alkaline electrolyte; aluminum, wherein a concentration of the aluminum is 10 millimolar to 250 millimolar, or 1 to 5 molar, preferably 2 to 3 molar, based on the total volume of the alkaline electrolyte; sulfur, wherein a concentration of the sulfur is 0.01 mM to 0.5 M, preferably 0.1 mM to 0.1 M, based on the total volume of the alkaline electrolyte; and tin, wherein a concentration of the tin is 30 millimolar to 500 millimolar, preferably 60 to 400 millimolar, based on the total volume of the alkaline electrolyte.
Aspect 4. An electrode for an electrochemical cell, the electrode comprising: iron; and an additive comprising a trivalent element, wherein a content of the additive is greater than 0.01 wt %, preferably 0.01 to 50 wt %, or more preferably 5 to 10 wt %, based on a total weight of the iron in the electrode.
Aspect 5. An electrode for an electrochemical cell, the electrode comprising: iron; and an additive comprising aluminum, sulfur, and tin, wherein a content of the aluminum is 5 to 10 wt %, based on a total weight of the iron in the electrode, wherein a content of the sulfur is 0.1 to 10 wt %, based on the total weight of the iron in the first electrode, and wherein a content of the tin is 0.1 to 10 wt %, based on the total weight of the iron in the first electrode.
Aspect 6. An electrochemical cell, comprising: a first electrode comprising iron; the alkaline electrolyte of any of Aspects 1 to 5; and a second electrode.
Aspect 7. An electrochemical cell, comprising: a first electrode comprising the electrode of any of the foregoing aspects; an alkaline electrolyte; and a second electrode.
Aspect 8. An iron-air battery, comprising: a plurality of the electrochemical cells, wherein the electrochemical cells are connected in series, parallel, or a combination thereof.
Aspect 9. A method of manufacturing an alkaline electrolyte, the method comprising: providing an alkaline solution having a total hydroxide concentration of greater than 1 molar, based on a total volume of the alkaline electrolyte; providing an additive comprising a trivalent element, tin, and sulfur; and contacting the alkaline solution and the additive to manufacture the alkaline electrolyte.
Aspect 10. A method of manufacturing an electrochemical cell, the method comprising: providing a cell stack comprising a first electrode, and a second electrode; and contacting the cell stack with the alkaline electrolyte according to any of the foregoing aspects to manufacture the electrochemical cell.
Aspect 11. A method of manufacturing an electrochemical cell, the method comprising: providing a cell stack comprising the first electrode according to any of the foregoing aspects, and a second electrode; and contacting the cell stack with an alkaline electrolyte to manufacture the electrochemical cell.
Aspect 12. A method of manufacturing an electrochemical cell, the method comprising: providing a cell stack comprising the first electrode and the second electrode; and contacting the cell stack with the alkaline electrolyte of any of the foregoing aspects to manufacture the electrochemical cell.
Aspect 13. A method of manufacturing an electrode, the method comprising: contacting iron and an additive comprising a trivalent element, sulfur, and tin to provide an electrode composition; and disposing the electrode composition on a substrate, or extruding or pressing the electrode composition to manufacture the electrode.
Aspect 14. A method of manufacturing an electrode, the method comprising: contacting iron, and an additive comprising aluminum, sulfur, and tin to provide an electrode composition; and disposing the electrode composition on a substrate, or extruding or pressing the electrode composition to manufacture the electrode.
Aspect 15. A method of manufacturing an iron-air battery, the method comprising: providing a plurality of the electrochemical cells of any of the foregoing aspects, and connecting the electrochemical cells in series, parallel, or a combination thereof to manufacture the iron-air battery.
Aspect 16. A method of operating an electrochemical cell, the method comprising: treating the electrochemical cell of any of the foregoing aspects to an operation temperature, wherein the operation temperature is 0° C. to 75° C.; and discharging the electrochemical cell to operate the electrochemical cell.

In any of the foregoing aspects, the trivalent element may be aluminum, scandium, yttrium, boron, or a combination thereof; the additive may comprise an aluminate; the concentration of the trivalent element may be 1 to 5 molar, preferably 2 to 3 molar, based on the total volume of the alkaline electrolyte; the trivalent element may be aluminum, and wherein a concentration of the aluminum may be 1 to 5 molar, preferably 2 to 3 molar, based on a total volume of the alkaline electrolyte; the additive may comprise a sulfide; the sulfur may be a reduction product or a dissociation product of the additive comprising a sulfide; a concentration of the sulfur may be 0.01 millimolar to 0.5 molar, preferably 0.1 millimolar to 0.1 molar, based on the total volume of the alkaline electrolyte; the additive may comprise the tin; the additive may comprise a stannate, preferably wherein the additive may comprise an alkali metal stannate; a concentration of the tin may be greater than 30 millimolar, preferably 30 to 500 millimolar, more preferably, 60 to 400 millimolar, based on the total volume of the alkaline electrolyte; the additive may comprise a single additive that comprises the trivalent element and the sulfur; the additive may comprise a single additive that comprises the trivalent element and the tin; the additive may comprise a single additive that comprises the trivalent element, the sulfur, and the tin; the additive may comprise a first additive comprising the trivalent element and a second additive comprising the sulfur; the alkaline additive may further comprise a third additive comprising the tin; the additive may comprise a first additive comprising the trivalent element and a second additive comprising the tin; the alkaline additive may further comprise a third additive comprising the sulfur; the alkaline electrolyte may have a total hydroxide concentration of 4 to 8 molar, based on the total volume of the alkaline electrolyte; the alkaline solution may comprise an alkali metal hydroxide, and the alkaline electrolyte may be in a form of a liquid, a gel, or combination thereof; the additive may further comprise iron having an oxidation state of 0, 2, 3, or a combination thereof; the alkaline electrolyte may comprise a sulfide, wherein the sulfide may be a transition metal sulfide, preferably a zinc sulfide; a concentration of the additive may be 0.01 to 500 millimolar, preferably 0.1 to 100 millimolar, based on the total volume of the alkaline electrolyte; the tin may be a stannate, wherein the stannate may be an alkali metal stannate; a concentration of the tin may be greater than 30 millimolar, preferably 30 to 500 millimolar, preferably 60 to 400 millimolar, based on the total volume of the alkaline electrolyte; the alkaline electrolyte may comprise a single additive that comprises the trivalent element and the sulfur; the alkaline electrolyte may comprise a single additive that comprises the trivalent element and the tin; the alkaline electrolyte may comprise a single additive that comprises the trivalent element, the sulfur, and the tin; the alkaline electrolyte may comprise a mixture of a first additive comprising the trivalent element and a second additive comprising the sulfur; wherein the mixture may further comprise a third additive comprising the tin; the additive may comprise a mixture of a first additive comprising the trivalent element and a second additive comprising the tin; wherein the mixture may further comprise a third additive comprising the sulfur; the alkaline electrolyte may have a total hydroxide concentration of greater than 1 molar, preferably 4 molar to 8 molar, based on the total volume of the alkaline electrolyte; the alkaline electrolyte may comprise an alkali metal hydroxide; the alkaline electrolyte may be in a form of a liquid, a gel, or a combination thereof; the additive may further comprise iron having an oxidation state of 0, 2, 3, or a combination thereof; the alkaline electrolyte may comprise a single additive comprising the aluminum, the sulfur, and the tin, wherein the additive has a concentration of 10 to 250 millimolar or 1 to 5 molar, based on the total volume of the alkaline electrolyte; the trivalent element may be aluminum, scandium, yttrium, boron, or a combination thereof, preferably aluminum; the additive may be an aluminate, and the content of the additive may be 5 to 10 wt %, based on the total weight of iron in the electrode; the additive may further comprise sulfur; a content of the sulfur in the electrode may be 0.01 to 5 wt %, or 1 to 10 wt %, preferably 3 to 7 wt %, based on a total weight of iron in the electrode; the additive may be a sulfide; the sulfur may be a reduction product or a dissociation product of an additive comprising sulfur; the additive may comprise a sulfide, preferably zinc sulfide; the additive may be a single additive that comprises the trivalent element and the sulfur; the additive may comprise a first additive that comprises the trivalent element and a second additive that comprises the sulfur, preferably wherein at least one of the first additive or the second additive may be a solid; the electrode may further comprise tin; a content of the tin may be 0.01 to 40 wt %, preferably 0.1 to 30 wt %, based on the total weight of the iron in the electrode; the tin may be an oxidation product or a dissociation product of an additive comprising tin, preferably wherein the additive may comprise a stannate; the stannate may be potassium stannate; the additive may be a single additive that comprises the trivalent element and the tin; the additive may comprise a first additive that comprises the trivalent element, and a second additive that comprises the tin; the additive may further comprise tin; a content of the tin may be 0.01 to 40 wt %, preferably 0.1 to 30 wt %, based on the total weight of the iron in the electrode; the tin may be an oxidation product or a dissociation product of an additive comprising tin, preferably wherein the additive comprises a stannate; the stannate may be potassium stannate; the additive may be an oxyanion, an oxide, a hydroxide, a sulfide, or a combination thereof; a concentration of the trivalent element may be 10 millimolar to 250 millimolar, preferably 20 millimolar to 200 millimolar, based on the total volume of the alkaline electrolyte; a concentration of the trivalent element may be 1 molar to 5 molar, preferably 2 molar to 3 molar, based on the total volume of the alkaline electrolyte; the method may comprise contacting the alkaline solution and a stannate to provide the alkaline electrolyte; the method may comprise contacting the alkaline solution and a sulfide to provide the alkaline electrolyte; the alkaline solution may comprise an alkali metal hydroxide; the method may further comprise disposing a separator between the first electrode and the second electrode; the electrode when discharged at 30° C. from 0.85V to 0.65V at a current of 20.5 mA/g, the electrode may provide at least 300 mAh/g; the electrode when discharged at 45° C. from 0.85V to 0.65V at a current of 20.5 mA/g, the electrode provides at least 250 mAh/g.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. For example, “an element” has the same meaning as “at least one element,” unless the context clearly indicates otherwise. Thus, reference to “an” element in a claim followed by reference to “the” element is inclusive of one element and a plurality of the elements.

“Or” means “and/or” unless clearly stated otherwise. Reference throughout the specification to “some embodiments,” “an embodiment,” “an aspect,” and so forth, means that a particular element described in connection with the embodiment and/or aspect is included in at least one embodiment and/or aspect described herein, and may or may not be present in other embodiments and/or aspects. In addition, it is to be understood that the described elements may be combined in any suitable manner in the various embodiments and/or aspects. A “combination thereof” is open and includes any combination comprising at least one of the listed components or properties optionally together with a like or equivalent component or property not listed.

The terms “comprises” and/or “comprising,” or “includes” and/or “including” or “contains” and/or “containing” when used in this specification, specify the presence of stated features, regions, integers, steps, operations, elements, and/or components, but do not preclude the presence or addition of one or more other features, regions, integers, steps, operations, elements, components, and/or groups thereof.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An alkaline electrolyte comprising:
an alkaline solution having a total hydroxide concentration of greater than 1 molar, based on a total volume of the alkaline electrolyte; and
an additive comprising
a trivalent element, wherein a concentration of the trivalent element is 1 millimolar to 5 molar, based on a total volume of the alkaline electrolyte,
sulfur, and
tin.

2. The alkaline electrolyte of claim 1, wherein the trivalent element is aluminum, scandium, yttrium, boron, or a combination thereof, optionally aluminum.

3. The alkaline electrolyte of claim 2, wherein the trivalent element is aluminum, optionally wherein the additive comprises an aluminate.

4. The alkaline electrolyte of claim 3, wherein the concentration of the trivalent element is 10 to 250 millimolar, based on the total volume of the alkaline electrolyte.

5. The alkaline electrolyte of claim 3, wherein the concentration of the trivalent element is 1 to 5 molar, based on the total volume of the alkaline electrolyte.

6. The alkaline electrolyte of claim 5,
wherein the trivalent element is aluminum, and
wherein a concentration of the aluminum is 1 to 5 molar, based on a total volume of the alkaline electrolyte.

7. The alkaline electrolyte of claim 3, wherein the additive comprises a sulfide, optionally zinc sulfide.

8. The alkaline electrolyte of claim 7, wherein the sulfur is a reduction product or a dissociation product of the additive comprising the sulfide.

9. The alkaline electrolyte of claim 1, wherein a concentration of the sulfur is 0.01 to 500 millimolar, based on the total volume of the alkaline electrolyte.

10. The alkaline electrolyte of claim 1, wherein the tin is stannate.

11. The alkaline electrolyte of claim 1, wherein a concentration of the tin is greater than 30 millimolar, based on the total volume of the alkaline electrolyte.

12. The alkaline electrolyte of claim 1, wherein the additive comprises a single additive that comprises the trivalent element and the sulfur.

13. The alkaline electrolyte of claim 1, wherein the additive comprises a single additive that comprises the trivalent element and the tin.

14. The alkaline electrolyte of claim 1, wherein the additive comprises a single additive that comprises the trivalent element, the sulfur, and the tin.

15. The alkaline electrolyte of claim 1, wherein the additive comprises a first additive comprising the trivalent element and a second additive comprising the sulfur.

16. The alkaline electrolyte of claim 15, further comprising a third additive comprising the tin.

17. The alkaline electrolyte of claim 1, wherein the additive comprises a first additive comprising the trivalent element and a second additive comprising the tin.

18. The alkaline electrolyte of claim 17, further comprising a third additive comprising the sulfur.

19. The alkaline electrolyte of claim 1, wherein the alkaline electrolyte has a total hydroxide concentration of 4 to 8 molar, based on the total volume of the alkaline electrolyte.

20. The alkaline electrolyte of claim 1, wherein the alkaline electrolyte comprises an alkali metal hydroxide, and the alkaline electrolyte is in a form of a liquid, a gel, or combination thereof.

21. The alkaline electrolyte of claim 1, wherein the additive further comprises iron having an oxidation state of 0, 2, 3, or a combination thereof.

22. An alkaline electrolyte comprising:
an alkaline solution having a total hydroxide concentration of greater than 1 molar, based on a total volume of the alkaline electrolyte;
a trivalent element, wherein a concentration of the trivalent element is 10 to 250 millimolar, or 1 to 5 molar, based on a total volume of the alkaline electrolyte;
tin; and
sulfur, wherein a concentration of the sulfur is 0.01 to 500 millimolar, based on the total volume of the alkaline electrolyte.

23. The alkaline electrolyte of claim 22, wherein the trivalent element is aluminum, optionally wherein the alkaline electrolyte comprises an aluminate.

24. The alkaline electrolyte of claim 22, wherein the alkaline electrolyte comprises a sulfide.

25. The alkaline electrolyte of claim 22, wherein the concentration of the sulfur is 0.01 to 500 millimolar, based on the total volume of the alkaline electrolyte.

26. The alkaline electrolyte of claim 22, wherein the tin is a stannate.

27. The alkaline electrolyte of claim 22, wherein a concentration of the tin is greater than 30 millimolar, based on the total volume of the alkaline electrolyte.

28. The alkaline electrolyte of claim 22, wherein the alkaline electrolyte comprises a single additive that comprises
the trivalent element and the sulfur,
the trivalent element and the tin, or
the trivalent element, the sulfur, and the tin.

29. The alkaline electrolyte of claim 22, wherein the alkaline electrolyte comprises a mixture of a first additive comprising the trivalent element and a second additive comprising the sulfur, optionally wherein the mixture further comprises a third additive comprising the tin.

30. The alkaline electrolyte of claim 22, wherein the additive comprises a mixture of a first additive comprising the trivalent element and a second additive comprising the tin, optionally wherein the mixture further comprises a third additive comprising the sulfur.

31. The alkaline electrolyte of claim 22, wherein the alkaline electrolyte has a total hydroxide concentration of 4 to 8 molar, based on the total volume of the alkaline electrolyte, optionally wherein the alkaline electrolyte comprises an alkali metal hydroxide, and the alkaline electrolyte is in a form of a liquid, a gel, or a combination thereof.

32. The alkaline electrolyte of claim 22, wherein the additive further comprises iron having an oxidation state of 0, 2, 3, or a combination thereof.

33. An alkaline electrolyte for an iron-air battery, the electrolyte comprising:
an alkaline solution having a total hydroxide concentration of greater than 1 molar, based on a total volume of the alkaline electrolyte;
aluminum, wherein a concentration of the aluminum is 10 millimolar to 250 millimolar, or 1 to 5 molar, based on the total volume of the alkaline electrolyte;
sulfur, wherein a concentration of the sulfur is 0.01 millimolar to 500 millimolar, based on the total volume of the alkaline electrolyte; and
tin, wherein a concentration of the tin is 30 millimolar to 500 millimolar, based on the total volume of the alkaline electrolyte.

34. The alkaline electrolyte of claim 33, wherein the alkaline electrolyte comprises a single additive comprising the aluminum, the sulfur, and the tin, wherein the additive has a concentration of 10 to 250 millimolar or 1 to 5 molar, based on the total volume of the alkaline electrolyte.

35. An electrode for an electrochemical cell, the electrode comprising:
iron; and
an additive comprising a trivalent element, wherein a content of the additive is greater than 0.01 wt %, based on a total weight of the iron in the electrode.

36. The electrode of claim 35, wherein the trivalent element is aluminum, scandium, yttrium, boron, or a combination thereof, optionally wherein the additive is an aluminate.

37. The electrode of claim 35, wherein the additive further comprises sulfur, optionally wherein a content of the sulfur in the electrode is 0.01 to 5 wt %, or 1 to 10 wt %, based on a total weight of iron in the electrode.

38. The electrode of claim 37, wherein the sulfur is a sulfide, optionally zinc sulfide.

39. The electrode of claim 37, wherein the additive is a single additive that comprises the trivalent element and the sulfur.

40. The electrode of claim 37, wherein the additive comprises a first additive that comprises the trivalent element and a second additive that comprises the sulfur, and wherein at least one of the first additive or the second additive is a solid.

41. The electrode of claim 35, wherein the additive further comprises tin, optionally wherein a content of the tin is 0.01 to 40 wt %, based on the total weight of the iron in the electrode.

42. The electrode of claim 41, wherein the tin is stannate, optionally wherein the stannate is an oxidation product or a dissociation product of the tin.

43. The electrode of claim 41, wherein the additive is a single additive that comprises the trivalent element and the tin.

44. The electrode of claim 41, wherein the additive comprises a first additive that comprises the trivalent element, and a second additive that comprises the tin.

45. The electrode of claim 41, wherein the additive is a single additive that comprises the trivalent element, the sulfur, and the tin.

46. The electrode of claim 41, wherein the additive comprises a first additive that comprises the trivalent element, a second additive that comprises the sulfur, and a third additive that comprises the tin.

47. The electrode of claim 35, wherein when discharged at 30° C. from 0.85V to 0.65V at a current of 20.5 mA/g, the electrode provides at least 300 mAh/g.

48. The electrode of claim 35, wherein when discharged at 45° C. from 0.85V to 0.65V at a current of 20.5 mA/g, the electrode provides at least 250 mAh/g.

49. An electrode for an electrochemical cell, the electrode comprising:
iron; and
an additive comprising aluminum, sulfur, and tin,
wherein a content of the aluminum is 5 to 10 wt %, based on a total weight of the iron in the electrode,
wherein a content of the sulfur is 0.1 to 10 wt %, based on the total weight of the iron in the electrode, and
wherein a content of the tin is 0.1 to 10 wt %, based on the total weight of the iron in the electrode.

50. An electrochemical cell, comprising:
a first electrode comprising iron;
the alkaline electrolyte of claim 1; and
a second electrode.

51. The electrochemical cell of claim 50, wherein the first electrode comprises
iron, and
an additive comprising a trivalent element, wherein a content of the additive is greater than 0.01 wt %, based on a total weight of the iron in the electrode.

52. An electrochemical cell, comprising:
a first electrode comprising the electrode of claim 35;
an alkaline electrolyte; and
a second electrode.

53. The electrochemical cell of claim 52, wherein the alkaline electrolyte
comprises:
an alkaline solution having a total hydroxide concentration of greater than 1 molar, based on a total volume of the alkaline electrolyte; and
an additive comprising
a trivalent element, wherein a concentration of the trivalent element is 1 millimolar to 5 molar, based on a total volume of the alkaline electrolyte,
sulfur, and
tin.

54. The electrochemical cell of claim 53, wherein the alkaline electrolyte comprises an alkali metal hydroxide, wherein the alkaline electrolyte has a total hydroxide concentration of greater than 1 molar, based on the total volume of the alkaline electrolyte, and wherein the alkaline electrolyte is a liquid, a gel, or a combination thereof.

55. An iron-air battery, comprising:
a plurality of the electrochemical cells of claim 50, wherein the electrochemical cells are connected in series, parallel, or a combination thereof.

56. An iron-air battery, comprising:
a plurality of the electrochemical cells of claim 52, wherein the electrochemical cells are connected in series, parallel, or a combination thereof.

57. A method of manufacturing an alkaline electrolyte, the method comprising:
providing an alkaline solution having a total hydroxide concentration of greater than 1 molar, based on a total volume of the alkaline electrolyte;
providing an additive comprising a trivalent element, tin, and sulfur; and
contacting the alkaline solution and the additive to manufacture the alkaline electrolyte.

58. The method of claim 57, wherein the additive is an oxyanion, an oxide, a hydroxide, a sulfide, or a combination thereof.

59. The method of claim 57, wherein the additive comprises a stannate.

60. The method of claim 57, wherein the additive comprises a sulfide, optionally wherein the sulfide is zinc sulfide.

61. The method of claim 57, wherein the trivalent element is aluminum, scandium, yttrium, boron, or a combination thereof, optionally wherein the aluminum is an aluminate.

62. The method of claim 57, wherein a concentration of the trivalent element is 10 millimolar to 250 millimolar, based on the total volume of the alkaline electrolyte.

63. The method of claim 57, wherein a concentration of the trivalent element is 1 molar to 5 molar, based on the total volume of the alkaline electrolyte.

64. The method of claim 57, wherein the alkaline solution comprises an alkali metal hydroxide.

65. A method of manufacturing an electrode, the method comprising:
contacting iron and an additive comprising a trivalent element, sulfur, and tin to provide an electrode composition; and
disposing the electrode composition on a substrate, or extruding or pressing the electrode composition to manufacture the electrode.

66. The method of claim 65,
wherein a content of the trivalent element, optionally aluminum, is 5 to 10 wt %, based on a total weight of the iron in the electrode,
wherein a content of the sulfur is 0.1 to 10 wt %, based on the total weight of the iron in the first electrode, and
wherein a content of the tin is 0.1 to 10 wt %, based on the total weight of the iron in the first electrode.

67. A method of manufacturing an electrochemical cell, the method comprising:
providing a cell stack comprising a first electrode, and a second electrode; and
contacting the cell stack with the alkaline electrolyte according to claim 1 to manufacture the electrochemical cell.

68. The method of claim 67, wherein the first electrode comprises iron, and
an additive comprising a trivalent element, wherein a content of the additive is greater than 0.01 wt %, based on a total weight of the iron in the electrode.

69. A method of manufacturing an electrochemical cell, the method comprising:
providing a cell stack comprising the first electrode of claim 36, and a second electrode; and
contacting the cell stack with an alkaline electrolyte to manufacture the electrochemical cell.

70. The method of claim 69, wherein the alkaline electrolyte is an alkaline solution having a total hydroxide concentration of greater than 1 molar, based on a total volume of the alkaline electrolyte; and comprises an additive comprising
a trivalent element, wherein a concentration of the trivalent element is 1 millimolar to 5 molar, based on a total volume of the alkaline electrolyte,
sulfur, and
tin.

71. A method of manufacturing an iron-air cell, the method comprising:
providing a cell stack comprising a first electrode and a second electrode; and
contacting the cell stack with an alkaline electrolyte comprising an alkaline solution having a total hydroxide concentration of greater than 1 molar, based on a total volume of the alkaline electrolyte; and
an additive comprising
a trivalent element, wherein a concentration of the trivalent element is 1 millimolar to 5 molar, based on a total volume of the alkaline electrolyte,
sulfur, and
tin to manufacture the iron-air cell.

72. The method of claim 71, further comprising disposing a separator between the first electrode and the second electrode.

73. A method of manufacturing an iron-air battery, the method comprising:
providing a plurality of the electrochemical cells of claim 50, and
connecting the electrochemical cells in series, parallel, or a combination thereof to manufacture an iron-air battery.

74. A method of manufacturing an iron-air battery, the method comprising:
providing a plurality of the electrochemical cells of claim 52, and
connecting the electrochemical cells in series, parallel, or a combination thereof to manufacture an iron-air battery.

75. A method of operating an electrochemical cell, the method comprising:
treating the electrochemical cell of claim 50 to an operation temperature, wherein the operation temperature is 0° C. to 75° C.; and
discharging the electrochemical cell to operate the electrochemical cell.

76. A method of operating an electrochemical cell, the method comprising:
treating the electrochemical cell of claim 52 to an operation temperature, wherein the operation temperature is 0° C. to 75° C.; and
discharging the electrochemical cell to operate the electrochemical cell.
